(19) United States
(12) Patent Application Publication
(10) Pub. No.: US 2006/0149858 A1
(43) Pub. Date: Jul. 6, 2006

(54) Establishing wireless universal serial bus (WUSB) connection via a trusted medium

(75) Inventors: Firdosh K. Bhesania, Kirkland, WA (US); Glen T. Slick, Bothell, WA (US); Randall E. Aull, Kenmore, WA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/246,510

(22) Filed: Oct. 7, 2005

Related U.S. Application Data
(63) Continuation-in-part of application No. 11/026,193, filed on Dec. 30, 2004.
(60) Provisional application No. 60/689,610, filed on Jun. 10, 2005.

(51) Int. Cl. G06F 3/00

(52) U.S. Cl. 710/5

(57) ABSTRACT

An extensible architecture for untrusted medium (e.g., wireless) device configuration via trusted medium. The architecture includes systems and methods for establishing a wireless universal serial bus (WUSB) connection between a connecting device and a host device using a trusted medium, such as a wired connection. In one implementation, the connecting device sends an association request through the trusted medium to the host device. The association request includes device attributes associated with the WUSB component of the connecting device. In response, the host device parses and validates the association request and determines connection attributes for connecting using WUSB. The host device sends a response with the connection attributes through the trusted medium to the connecting device. Using the connection attributes, the connecting device configures the WUSB component and establishes a WUSB connection with the host device.

### CROSS-REFERENCE TO RELATED APPLICATIONS

This application claims the benefits of an earlier filed provisional application, Application No. 60/689,610, filed Jun. 10, 2005.

This application is a continuation-in-part of and claims the benefits of an earlier filed non-provisional application titled “EXTENSIBLE ARCHITECTURE FOR UNTRUSTED MEDIUM DEVICE CONFIGURATION VIA TRUSTED MEDIUM”, application Ser. No. 11/026,193, filed Dec. 30, 2004.

### SUMMARY OF THE INVENTION

The following presents a simplified summary of the subject invention in order to provide a basic understanding of some aspects of the subject invention. This summary is not an extensive overview of the subject invention. It is not intended to identify key/critical elements of the subject invention or to delineate the scope of the subject invention. Its sole purpose is to present some concepts of the subject invention in a simplified form as a prelude to the more detailed description that is presented later.

An extensible architecture for untrusted medium (e.g., wireless) device configuration via trusted medium is described below. The architecture can be employed to associate a device that utilizes an untrusted medium (e.g., wireless connection). Association is effected using a trusted medium, for example, a wired connection.

The architecture includes systems and methods for establishing a wireless universal serial bus (WUSB) connection between a connecting device and a host device using a trusted medium, such as a wired connection. In one implementation, the connecting device sends an association request through the trusted medium to the host device. The association request includes device attributes associated with the WUSM component of the connecting device. In response, the host device parses and validates the association request and determines connection attributes for connecting using WUSB. The host device sends a response with the connection attributes through the trusted medium to the connecting device. Using the connection attributes, the connecting device configures the WUSB component and establishes a WUSB connection with the host device.

### BRIEF DESCRIPTION OF THE DRAWINGS

FIG. 1 is a block diagram of an association architecture in accordance with an aspect of the subject invention.

FIG. 2 is a diagram of an association request in accordance with an aspect of the subject invention.

FIG. 3 is a diagram of an associate response in accordance with an aspect of the subject invention.

FIG. 4 is a block diagram of an association management system in accordance with an aspect of the subject invention.

FIG. 5 is a block diagram of an association management system in accordance with an aspect of the subject invention.

FIG. 6 is a block diagram of an association handler system in accordance with an aspect of the subject invention.

FIG. 7 is a block diagram of an association driver system in accordance with an aspect of the subject invention.

FIG. 8 is a flow chart of a method of associating a device in accordance with an aspect of the subject invention.

FIG. 9 is a flow chart of a method facilitating association of a device in accordance with an aspect of the subject invention.

FIG. 10 is a flow chart of a method of associating a device via a USB connection in accordance with an aspect of the subject invention.

FIG. 11 is a flow chart further illustrating the method of FIG. 10.

FIG. 12 is a flow chart further illustrating the method of FIGS. 10 and 11.

FIG. 13 is a flow chart of an association management method in accordance with an aspect of the subject invention.

FIG. 14 is a flow chart of an association management method in accordance with an aspect of the subject invention.

FIG. 15 is a flow chart further illustrating the method of FIG. 14.

FIG. 16 is a flow chart further illustrating the method of FIGS. 14 and 15.

FIG. 17 is a flow chart of an association handler method in accordance with an aspect of the subject invention.

FIG. 18 illustrates an example operating environment in which the invention may function.

FIG. 19 shows an example of a PONG system.

FIG. 20 shows an example USB driver stack for a device manager architecture of an operating system.

FIG. 21 shows example operations for a WUSB device to connect to a host device.

FIG. 22 shows an example process for connecting a WUSB device with a host device using the system described herein.

FIG. 23 shows an example process for associating a device using the particular data structures described herein.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

As used in this application, the terms “component,” “handler,” “model,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). Computer components can be stored, for example, on computer readable media including, but not limited to, an ASIC (application specific integrated circuit), CD (compact disc), DVD (digital video disk), ROM (read only memory), floppy disk, hard disk, EEPROM (electrically erasable programmable read only memory) and memory stick in accordance with the subject invention.

Further, “trusted medium” refers to a trusted connection over which association information can be transferred in order to associate an untrusted medium. Examples of trusted media include, but are not limited to, a serial connection, a parallel connection and/or a universal serial bus (USB) connection “Untrusted medium” refers to a medium which is being associated in order to establish trust. Wireless connection(s) such as Bluetooth and/or IEEE 802.11 are examples of untrusted media.

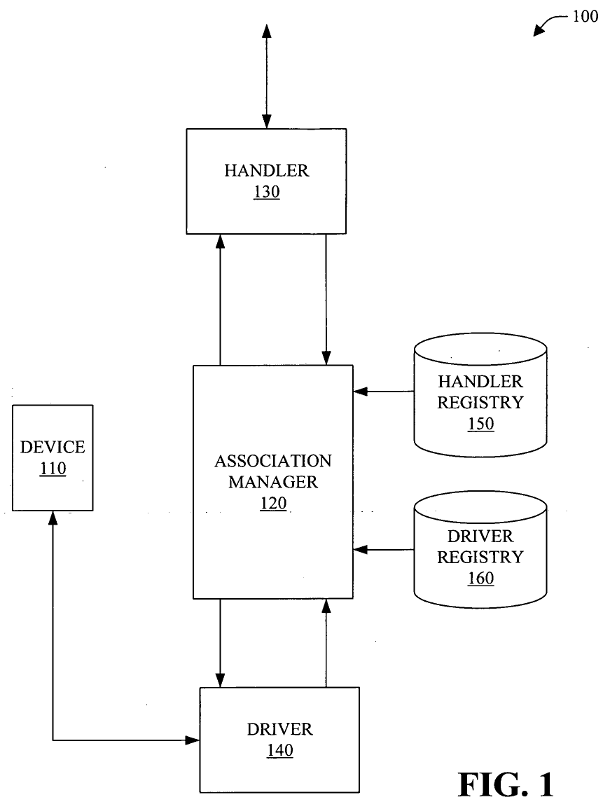

Referring to FIG. 1, an association architecture 100 in accordance with an aspect of the subject invention is illustrated. The architecture 100 can be employed to associate a device 110 that utilizes an untrusted medium (e.g., wireless connection). Association is effected using a trusted medium, for example, a wired connection.

An “association request” refers to a block of data sent from the device 110 to a driver 120 in order to initiate association. The association request can then be forwarded to an association manager 130 which forward to the association request to an appropriate handler 140. An “association response” refers to a block of data sent from the driver 120 to the device 110 in order to complete association (e.g., successful and/or unsuccessful).

The architecture 100 can facilitate configuration of the device 110 to communicate (e.g., securely) via an untrusted medium (e.g., wireless connection). Configuration of the device 110 can be based, at least in part, upon information exchanged via a trusted medium (e.g., wired connection). In one example, the device 110 sends an association request to the driver 120 and receives an association response from the driver 120. If the association is successful, the association response can include, for example, configuration information (e.g., encryption key) to enable the device 110 to communicate (e.g., securely) via the untrusted medium. If the association is unsuccessful, the association response can include, for example, error information.

In one example, the device 110 is a wireless-enabled digital camera that also includes a USB connection. The USB connection (trusted medium) can be employed to configure the wireless connection (untrusted medium) of the digital camera. For example, a “found new hardware” wizard can be employed to choose and/create a wireless profile to transfer to the digital camera via the architecture 100. Once the profile information has been transferred to the digital camera via the USB connection, the USB connection can be disconnected and the digital camera can communicate via the wireless connection.

For example, the driver 120 can channel an association request received via a trusted medium from a device 110 to the association manager 130. The driver 120 further can provide an association response received from the association manager 130 to the device 110 via the trusted medium. In another example, the driver 120 generates and provides an association request to the association manager 130. Optionally, the driver 120 can further determine an appropriate time for issuance of an association request.

In yet another example, a particular driver 120 can be employed to configure a plurality of untrusted media. For example, a driver 120 can be employed to communicate via a USB connection to a plurality of devices 110 that communicate via a plurality of untrusted media.

The association manager 130 provides association data to the appropriate components. The association manager 130 can receive an association request from a driver 120. Based, at least in part, upon routing information in the association request, the association manager 130 can provide information associated with the association request to a particular handler 140 for processing. Once the particular handler 140 has completed processing of the association request, the handler 140 can provide an association response to the association manager 130. Based, at least in part, upon routing information in the association response, the association manager 130 can provide the association response to the requesting driver 120.

The handler 140 interfaces with a service (not shown) that implements device installation. In one example, the handler 140 is the only component of the architecture 100 that has explicit knowledge of the association request. The handler 140 take action based, at least in part, upon contents of the association request, as described in greater detail below. For example, the action(s) can be dependent upon the connection type sought to be established by the association request. Once the particular handler 140 has completed processing of the association request, the handler 140 can provide an association response to the association manager 130.

The architecture 100 can include a handler registry 150 which stores identification information associated with one or more handlers 140. The association manager 130 can employ the identification information stored in the handler registry 150 to determine to which of a plurality of handlers 140 to provide a particular association request.

Further, the architecture 100 can, optionally, include a driver registry 160 that stores identification information associated with one or more drivers 120. The association manager 130 can employ the identification information stored in the driver registry 160 to determine which of one or more drivers 120 to instantiate, for example, during initialization (as discussed below).

While depicted as a single entity, those skilled in the art will recognize that the device 110 can include an object that sends and/or receives association requests and an object (e.g., target device) that ultimately is associated with a host.

In one example, the architecture 100 supports only one association request and associated association response. In this example, the information needed from the device 110 to facilitate association is embedded in the association request. Similarly, the information needed for the device 110 to facilitate association is embedded in the association response.

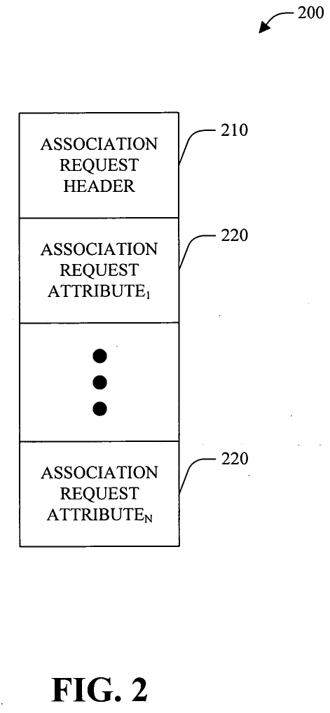

Referring to FIG. 2, an association request 200 in accordance with an aspect of the subject invention is illustrated. The association request 200 includes an association request header 210 and one or more association request attribute(s) 220 (e.g., attribute type, length and data). An attribute is a single item within an association request and/or response. For example, the association request header 210 can include a set of globally defined request attribute(s) similar in format to those described below with respect to association request attribute(s) 220.

In one example, association request(s) and/or association response(s) are organized in a parse-able stream. The stream comprises a series of attribute(s) with each attribute having a defined type and associated data. This facilitates flexibility and extensibility of the architecture. An exemplary attribute structure is set forth in Table 1:

TABLE 1

| Byte | Field | | |
|---|---|---|---|
| Offset | Length | Field Name | Description |
| 0 | 2 | AttributeType | Identifier that describes the |
| | | | particular attribute. |
| 2 | 2 | AttributeDataLength | The length in bytes of the data |
| | | | field of this attribute |
| 4 | 0-0xFFFF | Data | Data for this particular |
| | | | attribute |

This exemplary attribute structure can be defined, for example, as:

TABLE 2

```
typedef struct _PNG_ATTRIBUTE {
      USHORT AttributeType;
      USHORT AttributeDataLength;
      PBYTE Data;
} PNG_ATTRIBUTE, *PPNG_ATTRIBUTE;
```

In one example, there are several pre-defined attribute types that are intended to be used by the system itself (e.g., common to many association types), and are not specific to any particular association type.

TABLE 3

| AttributeType | | | |
|---|---|---|---|
| Value | Attribute Name | AttributeDataLength | Description |
| 0x0000 | AssociationType | Sizeof(GUID) | This is the identifier |
| | | | of the type of |
| | | | association data is to |
| | | | follow. It is a |
| | | | unique GUID that is |
| | | | defined when the |
| | | | handler is defined. |
| | | | This value can be |
| | | | used for two |
| | | | purposes. First it |
| | | | defines what |
| | | | software component |
| | | | should handle the |
| | | | association request |
| | | | (e.g., a Bluetooth |
| | | | Handler). Second, it |
| | | | defines the scope for |
| | | | the attributes to |
| | | | follow, since most |
| | | | attribute types only |
| | | | have to be unique |
| | | | with respect to their |
| | | | AssociationType. |
| 0x0001 | Length | 4 | This is the total |
| | | | length of the |
| | | | Request or |
| | | | Response, including |
| | | | the AssociationType |
| | | | and Length |
| | | | attributes. |
| 0x002 | MaximumResponseLength | 4 | This is the |
| | | | maximum supported |
| | | | length in bytes of |
| | | | Association |
| | | | Response. This can |
| | | | be determined, for |
| | | | example, by the |
| | | | device's resource |
| | | | constraints. |
| 0x0003 | AssociationStatus | 4 | This is the status for |
| | | | the association and |
| | | | is included in the |
| | | | Response. |
| 0x0004-0x1000 | RESERVED | 0-0xFFFF | In this example, |
| | | | these AttributeType |
| | | | values are reserved |
| | | | for future use and |
| | | | are not be used for |
| | | | any |
| | | | AssociationType |
| | | | specific attributes. |

TABLE 4

| Value | Name | Description |
|---|---|---|
| 0x0000 | ASSOCIATION_SUCCESS | Association was |
| | | completed |
| | | successfully, and the |
| | | response is |
| | | valid. |
| 0xC001 | ERROR_MALFORMED_ASSOCIATION_REQUEST | The association |
| | | request was not |
| | | formed correctly. |
| 0xC002 | ERROR_ASSOCIATION_TYPE_NOT_SUPPORTED | The association |
| | | type specified in |
| | | the Association |
| | | Request does not |
| | | have a registered |
| | | handler. |

Association Request

In this example, an association request is a series of attributes. The first attribute is the AssociationType. This is used to identify which handler to which the request should be directed. In this example, this value is a GUID that is defined by the handler (or some specification associated with the handler). For example, in order to associate a Bluetooth device, there can be a Bluetooth specific GUID, and a handler that has specified that it handles that particular GUID.

The second attribute in the association request is the length. This is the total length of all of the attributes in this request including the AssociationType and Length field itself. This is used to aide in parsing, so that if a component is not interested in a specific AssociationType, it can skip over the whole request as opposed to having to parse each attribute within it.

In this example, the attribute(s) that immediately follow the length are defined carefully in order to facilitate simple devices to be able to implement basic association with minimal processing (e.g., device(s) having silicon-only solutions with no firmware). In order to achieve this, being able to simply jump to a pre-defined offset in a structure in order to extract desired data can be helpful. Thus, in this example, the attributes immediately following the length contain the minimal amount of data needed to carry out basic association. Further, the attributes can be laid out in a pre-defined order and always be present. In one example, substantially all of this required data is contained within a single attribute. In this example, any variable length fields are located at the end of these basic attributes so as to not affect the offset in the association request.

In another example, several attributes are employed, each containing a small amount of data. Thus, it is to be appreciated that any number of attribute(s), if any, can follow, for example, in order to provide extended functionality.

Association Response

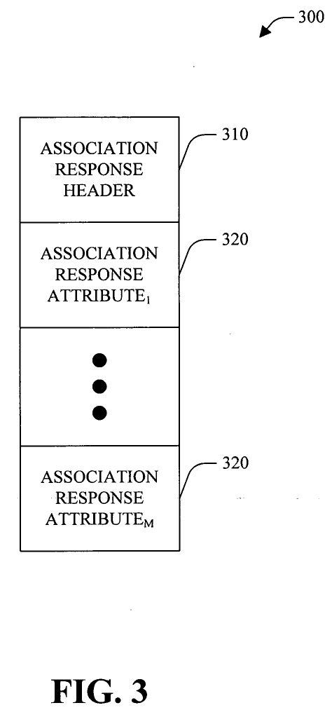

Turning to FIG. 3, an associate response 300 in accordance with an aspect of the subject invention is illustrated. The association response 300 includes an association response header 310 and zero, one or more association response attribute(s) 320. For example, the association response header 310 can include a set of globally defined request attribute(s) similar in format to those described below with respect to association response attribute(s) 320.

An association response attribute 320 is a piece of data comprising an attribute type, length, and data. Similar to the association request discussed above, in one example, the association response is a series of attributes. In this example, the first attribute is the AssociationType. This is used to echo the AssociationType of the association request that resulted in this response.

The second attribute in the association response is the length. This is the total length of all of the attributes in this request including the AssociationType and length field itself. This is used to aide in parsing, so that if a component is not interested in a specific AssociationType, it can skip over the response as opposed to having to parse each attribute within it.

The third attribute of the association response is the AssociationStatus. This is to notify the device as to the result of the association request. In this example, if the association process was successful, then this value will be 0x0000, meaning that the device can continue to read the attributes in the association response. If the value is 0xc0001, then the host could not find a handler that can handle the specified AssociationType. In this case, the device should not make any assumptions about further attributes in the association response.

The attribute(s) immediately following the AssociationStatus can be defined carefully as discussed above to allow simple devices to be able to implement basic association with minimal processing. In this example, in order to achieve this, being able to simply jump to a pre-defined offset in a structure in order to extract desired data is necessary. So these attributes contain the minimal amount of data needed to carry out basic association. They are also laid out in a pre-defined order and always be present in this example. Any variable length fields are located at the end of these basic attributes so as to not affect the offset in the association request. Any number of attributes, if any, can follow in order to provide extended functionality.

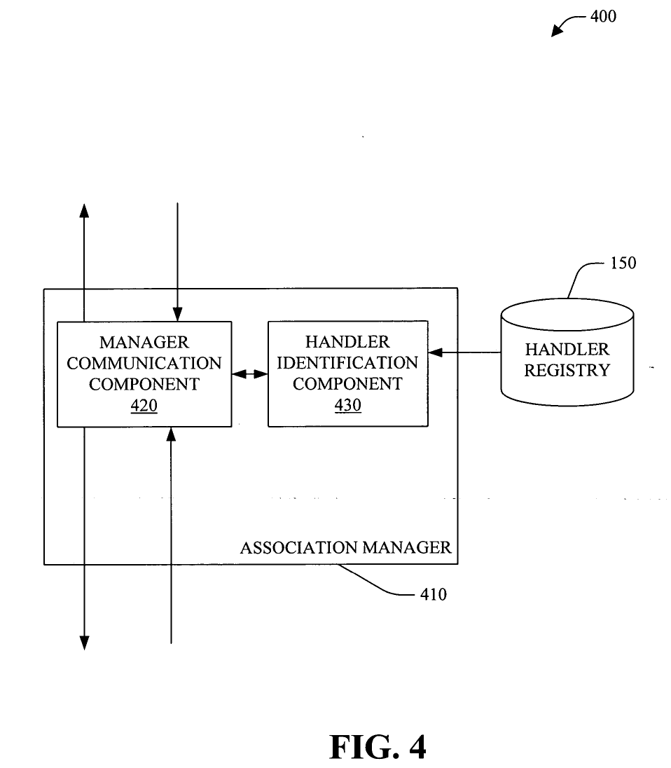

Referring to FIG. 4, an association management system 400 in accordance with an aspect of the subject invention is illustrated. The association management system 400 includes an association manager 410 having a manager communication component 420 and a handler identification component 430. The system 400 further includes a handler registry 150, and, optionally, a driver registry 160.

The association manager 410 is responsible for providing association data (e.g., association request(s) and/or association response(s)) to the appropriate components (e.g., handler and/or driver). The manager communication component 420 can receive association request(s) from driver(s) (not shown). The manager communication component 420 can provide at least part of the association request (e.g., association request header) to the handler identification component 430.

Based on the information provided by the manager communication component 420 and identification information stored in the handler registry 150, the handler identification component 430 identifies the particular handler (not shown) to which the association request is to be provided. In one example, the association manger 410 loads the handler identified by the handler identification component 430. In another example, handler(s) are loaded at initialization (as discussed in greater detail below). Thereafter, the manager communication component 420 provides information associated with the association request to the handler identified by the handler identification component 430.

Once the handler has processed the association request, the handler provides an association response to the manager communication component 420. The manager communication component 420 then provides the association response to the requesting driver.

In one example, the association manager 410 validates the association request. For example, the association manager 410 can determine whether is well-formed. If the request is not well-formed, then the association manager 410 can generate an association response indicating the association request was malformed (e.g., status attribute set to ERROR_MALFORMED_ASSOCIATION_REQUEST) and provide the association response to the requesting driver. In this example, the association manager 410 utilizes the following criteria to determine whether an association request is well-formed:
a. The request length is at least large enough to hold the Association Type and Length attributes (e.g., 36 bytes);
b. The first attribute is the Association Type and its length is of the appropriate size (e.g., based on a globally unique identifier (GUID) associated with the particular handler);
c. The second attribute is the Length and is of the appropriate size (e.g., ULONG);
d. The value of the Length attribute is greater than the Association Type and Length attributes (e.g., 36 bytes), and is less than or equal to the length of the request;
e. Each following attribute has a length that when added to its current position in the request does not result in a value greater than the value in the Length attribute;
f. Exactly one association type attribute and exactly one Length attribute is present in the request.

Next, the association manager 410 determines if there is a handler that has registered for the specified association type included in the association request (e.g., GUID stored in the handler registry 150). If a handler is not found, then the association manager 410 can generate an association response indicating that the association type requested is not supported and provide the association response to the requesting driver.

If a handler is found, in this example, the association manager 410 can parse the association request and extract a list of attribute(s). The association manager 410 can then provide the list of extracted attribute(s) to the particular handler.

If the association manager 410 is unsuccessful in providing the list of extracted attribute(s) to the particular handler, the association manager 410 can generate an association response indicating that the particular handler was not responsive and provide the association response to the requesting driver.

If the association manager 410 is successful in providing the list of extracted attribute(s) the particular handler, upon completion of processing by the handler, in this example, the association manager 410 receives an association response attribute list from the handler. The association manager 410 can determine whether the association response attribute list is well-formed. For example:
a. There is exactly one status attribute;
b. A Length attribute and an association type attribute are not present (e.g., to be added by the association manager 410);
c. If the association request-included a maximum response length attribute, then the total size of the attributes must be less than that value.

If the response is well-formed, then the association manager 410 generates an association response (e.g., byte array) based, at least in part, upon the association response attribute list. For example, the association manager 410 can:
a. Add up the total size of all attributes in the response attribute list;
b. Add the size required for the association type and length attributes;
c. Allocate a buffer large enough to hold the response;
d. Set the first attribute in the buffer to the association type from the association request;
e. Add the length attribute to the buffer using the calculated response length.
f. Add an association status attribute;
g. Add each additional attribute in the order that they were in the list.

The association manager 410 can then provide the association response to the requesting driver.

In one example, the association manager implements the following interface:

TABLE 5
interface IManager
{
HRESULT SendAssociationRequest(BYTE* AssociationRequest,
ULONG AssociationRequestLength, PBYTE *AssociationResponse,
PULONG AssociationResponseLength);
}

SendAssociationRequest( ) is called by driver(s) in order to begin the association process. The association response is returned as a byte array which can easily be sent back to the device. In one example, it is the responsibility of the driver to free the AssociationResponse.

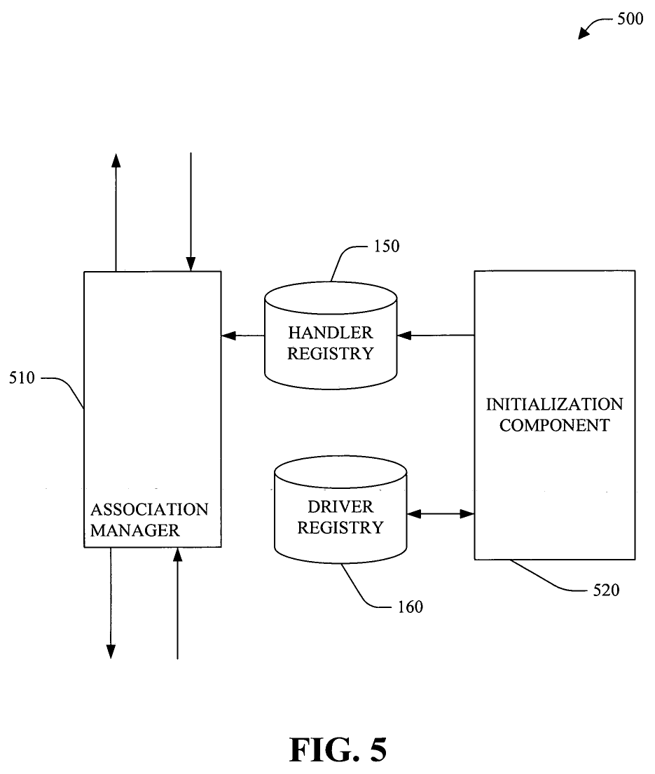

Turning to FIG. 5, an association management system 500 in accordance with an aspect of the subject invention is illustrated. The system 500 includes an association manager 510, a handler registry 150, a driver registry 160 and an initialization component 520.

The association manager 510 is responsible for providing association data (e.g., association request(s) and/or association response(s)) to the appropriate components (e.g., handler and/or driver), as discussed previously. However, in this example, the initialization component 520 employs information stored in the driver registry 160 to determine which of one or more drivers (not shown) to instantiate, for example, during initialization of the system 500. For example, driver(s) can be registered during configuration of a computer system (not shown) (e.g., manually and/or automatically).

In one example, upon system initialization, the initialization component 520 identifies driver(s) and handler(s) based, at least in part, upon information stored in the driver registry 160 and handler registry 150, respectively. Thereafter, the initialization component 520 creates instances of the identified handler(s) and the identified driver(s).

In this example, for each of the handlers, the association manager 510 can retrieve an association type count and allocate an associated storage buffer (e.g., association type count * sizeof (GUID)). This buffer can be used to retrieve the association types from the handler. In another example, the handler allocates the storage space and provides it to the association manager.

The association types can be an array of GUIDs that represent the specific association types that the handler supports. For each of the GUIDs retrieved, an entry can be added to a list of GUID to Handler mappings stored in the handler registry. For example:

TABLE 6

```
typedef struct _ASSOCIATION_TYPE_MAPPING {
      GUID AssociationType;
      IHandler Handler;
} ASSOCIATION_TYPE_MAPPING,
*PASSOCIATION_TYPE_MAPPING;
```

This list of mappings can then be employed by the association manager 510 to determine routing of association requests to the appropriate handler.

In this example, once the handlers have been created and their association types discovered, the initialization component 520 activates the drivers. Activation occurs after the handlers have been loaded and initialized to ensure that association request(s) are not received until the handlers have been discovered and loaded. For example, to activate a driver, a “Start( )” method can be invoked.

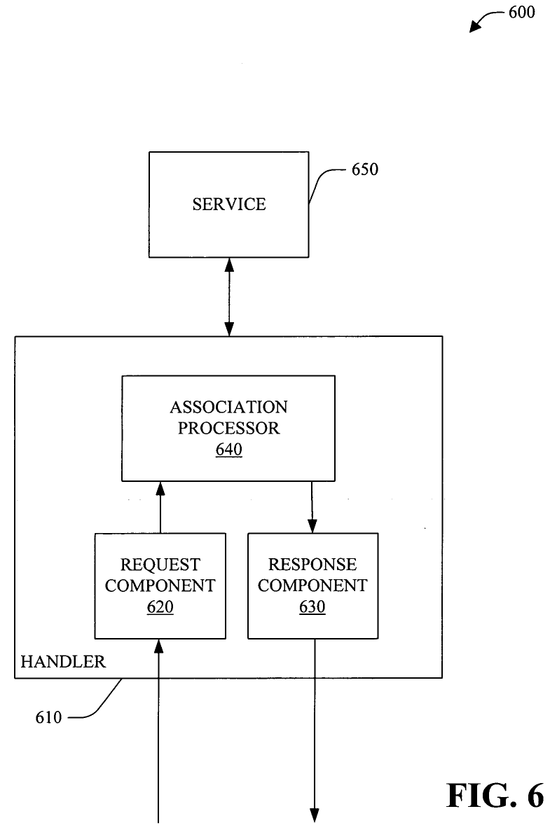

Next, referring to FIG. 6, an association handler system 600 in accordance with an aspect of the subject invention is illustrated. The system 600 includes a handler 610 comprising a request component 620, a response component 630 and an association processor.

The handler 610 (along with possibly other component(s) (not shown)) consumes the association request and generates information associated with an association response.

For example, the request component 620 can receive information associated with an association request (e.g., the association request and/or a parsed list of attributes) from an association manager (not shown). The request component 620 can parse the contents of the information associated with the association request to determine what action(s) are to be taken. The association processor 640 facilitates action(s) via the service 650. Action(s) of can be dependent upon, for example, the connection type sought to be established. Once the action(s) have been completed, the association processor 640 can provide information regarding the association to the response component 630. The response component 630 can then generate information associated with an association response (e.g., an association response and/or list of attributes) which can be provided to the association manager.

In one example, a plurality of handlers 610 implement the following COM interface:

TABLE 7

```
interface IPngHandler
{
      // Properties
      HRESULT Manager([in] IPngMgr newVal);
      HRESULT AssociationTypes([out, retval] PGUID *pVal);
      HRESULT AssociationTypeCount([out, retval] short* pVal);
      // Methods
      HRESULT HandleAssociationRequest(IAttributeList*
RequestAttributes, IAttributeList** ResponseAttributes);
```

In this example, “manager” is an interface pointer to the association manager. Further, “AssociationTypes” returns an array of AssociationType GUIDs that the PONG Handler can handle. Similarly, “AssociationTypeCount” is the number of AssociationTypes that the PONG Handler can handle. “HandleAssociationRequest( )” is called by the association manager when it receives an association request that the handler 610 reported it supported. “RequestAttributes” is a list of attribute structures. The handler 610 is expected to allocate the memory necessary to return the ResponseAttributes which is a list of attribute structures which are the attributes that will be returned to the device (not shown).

In another example, the handler 610 stores information about the device, for example, in a database for future installation once the device is discovered on the target medium. For example, a particular handler 610 can be related to a Wi-Fi target medium. In this example, device(s) desiring to employ the Wi-Fi target medium send association request(s) and receive association response(s) in the form of attribute lists. The attribute lists can be provided by the handler 610 to an association manager which can then form an association response.

With respect to Tables 9, 10 and 11 below, “attribute” refers to a friendly name associated with an attribute element. “Attribute ID” is an identifier (e.g., number) used to identify the attribute element in the attribute list. “Length” refers to the length of the data in an attribute element. Attribute lengths can be varied and/or fixed and, in this example, are expressed in bytes. A length value can also specify a maximum length. In the association response, in one example, fixed lengths can be used so that the offset to the value is deterministic; aiding the ability of a device to parse the response. The actual value of the attribute may not use up the entire length allocated for the data. In these cases, an additional field can specify the actual length of the attributes data. “Allowed Values” refers to the allowed values field describes the values to be supported by the device. If an allowed value is required, it means the device must support that value if it contained in the attribute list. Unless otherwise stated in Tables 9, 10 and/or 11, values should be assumed to be required. If an allowed value is optional, the device need not support the value, but should be prepared for it to be contained in the attribute list. Optional values may become required in future versions of this specification.

Wireless Protocols

The IEEE 802.11 set of standards defines two network types: encrypted networks (e.g., WEP networks) and unencrypted networks. Owing to the well-known weaknesses of the WEP protocol, the wireless industry implemented support for the IEEE 802.1x standard as a mechanism for addressing the key deficiencies in the WEP protocol, those being user authentication, encryption key management and encryption key distribution. For WEP-encrypted networks, the user needs to provide an encryption key and for 802.1× enabled networks the key is provided automatically if the user has a valid credential (e.g., such as a digital certificate or username and password). For 802.11 networks which are encrypted, this presents a usability problem as it is currently not possible to determine a priori whether the user needs to enter the WEP key or whether the network supports 802.1×, in which case they do not have to enter it.

To address the underlying weaknesses of the WEP algorithm, which has been shown to be cryptographically weak, a security enhancement to the 802.11 set of standards was introduced, called Wi-Fi Protected Access (WPA). WPA also addresses some of the usability issues of the original 802.11 standard by specifying an information element which WPA-capable access points include in their beacon frame. This information element describes inter alia whether the network requires the user to enter the encryption key called WPA pre-shared key mode (WPA-PSK) or whether the key is provided automatically by virtue of the user's credential, referred to as “WPA mode”.

Wired Equivalent Privacy

WEP is defined by the IEEE 802.11 standard and is intended to provide a level of data confidentiality that is equivalent to a wired network. Due to the nature of wireless LAN networks, implementing a security infrastructure that monitors physical access to the network can be difficult. Unlike a wired network where a physical connection is required, anyone within range of a wireless access point (AP) can conceivably send and receive frames as well as listen for other frames being sent. This makes eavesdropping and remote sniffing of wireless LAN frames very easy.

WEP provides data confidentiality services by encrypting the data sent between wireless nodes. WEP encryption for an 802.11 frame is indicated by setting a WEP flag in the MAC header of the 802.11 frame. WEP provides data integrity for random errors by including an integrity check value (ICV) in the encrypted portion of the wireless frame.

The following tables illustrates the two shared keys that WEP defines:

TABLE 8

| Key type | Description |
|---|---|
| Multicast/global key | Encryption key that helps to protect |
| | multicast and broadcast traffic from a |
| | wireless AP to all of its connected wireless |
| | clients. |
| Unicast session key | Encryption key that helps to protect unicast |
| | traffic between a wireless client and a |
| | wireless AP and multicast and broadcast |
| | traffic sent by a wireless client to the |
| | wireless AP. |

WEP encryption employs the RC4 symmetric stream cipher with 40-bit and 104-bit encryption keys.

Wi-Fi Protected Access

WPA is a Wi-Fi standard designed to improved upon the security features of WEP. Unlike WEP, 802.1x authentication is required in WPA. With WPA, rekeying of both unicast and global encryption keys is required. For the unicast encryption key, the Temporal Key Integrity Protocol (TKIP) changes the key for every frame, and the change is synchronized between the wireless client and the wireless access point (AP). For the global encryption key, WPA includes a facility for the wireless AP to advertise the changed key to the connected wireless clients.

TKIP replaces WEP with an encryption algorithm that is stronger than the WEP algorithm. TKIP also provides for verification of the security configuration after the encryption keys are determined; synchronized changing of the unicast encryption key for each frame; and, determination of a unique starting unicast encryption key for each pre-shared key authentication.

WPA further employs a method know as “Michael” that specifies an algorithm that calculates an 8-byte message integrity code (MIC). The MIC is placed between the data portion of the IEEE 802.11 frame and the 4-byte integrity check value (ICV). The MIC field is encrypted together with the frame data and the ICV.

WPA is an interim standard that will be replaced with the IEEE's 802.11i standard upon its completion.

Wi-Fi Handler

The association type is an attribute contained in the header section of the association request and association response, and is separate from data attributes. This attribute is used by the association manager to forward the association request(s) to the correct handler. In this example, a Wi-Fi handler 410 has the following required association type:

TABLE 9

| Attribute: | Attrib ID | Length | R/O | Allowed Values |
|---|---|---|---|---|
| Association | 0x0000 | 16B | R | F55BDC92-7827-4C91-B784- |
| type | | | | 0EC8A152FADA |

The data section of the association request includes attributes that are specific to the attribute type. The following table identifies exemplary attributes that an association manager can forward to a Wi-Fi handler 610:

TABLE 10

| | Attrib | | | |
|---|---|---|---|---|
| Attribute: | ID | Length | R/O | Allowed Values |
| MAC Address | 0x1001 | 6B | O | A 48 bit value corresponding to the |
| | | | | 802.11 interface on the device |
| Network | 0x1002 | 2B | R | These flags allow a device to |
| Authentication | | | | communicate which types of |
| Type Flags | | | | Network Auth types are supported. |
| | | | | (1 = supported, 0 = not supported): |
| | | | | The value of this field is a bitwise |
| | | | | OR of one or more of the following values: |
| | | | | 0x0001 = Open |
| | | | | 0x0002 = WPAPSK |
| | | | | 0x0004 = Shared |
| | | | | 0x0008 = WPA |
| | | | | 0x0010 = WPA-NONE |
| | | | | 0x0020 = WPA2 |
| | | | | All other values are reserved and |
| | | | | shall be set to 0. |
| Data Encryption | 0x1003 | 2B | R | These flags allow a device to |
| Type Flags | | | | communicate which types of “Data |
| | | | | Encryption type” are supported. |
| | | | | (1 = supported, 0 = not supported): |
| | | | | The value of this field is a bitwise |
| | | | | OR of one or more of the following |
| | | | | values: |
| | | | | 0x0001 = WEP |
| | | | | 0x0002 = TKIP |
| | | | | 0x0004 = AES |
| | | | | All other values are reserved and |
| | | | | shall be set to 0 |
| Connection | 0x1004 | 1B | R | These flags allow a device to |
| Type Flags | | | | communicate which types of |
| | | | | “Connection type” are supported. |
| | | | | (1 = supported, 0 = not supported): |
| | | | | The value of this field is a bitwise |
| | | | | OR of one or more of the following |
| | | | | values: |
| | | | | 0x01 = ESS |
| | | | | 0x02 = IBSS |
| | | | | All other values are reserved and |
| | | | | shall be set to 0 |

MAC Address

The MAC Address is 6 byte value that contains the 48 bit value of the MAC Address. For example: 0x00 0x07 0xE9 0x4C 0xA8 0x1C.\

Network Authentication Type Flags

This set of flags allows a device to signal which “Network Authentication type” types are supported. This information can be used for diagnostic purposes. If a device fails to support the required attributes, then the user can be notified of this and given actionable instructs to correct the problem. In this example, the value of this field is a bitwise OR of one or more of the following values:
0x0001=Open
0x0002=WPAPSK
0x0004=Shared
0x0008=WPA
0x0010=WPA-NONE
0x0020=WPA2

In this example, other values are reserved and set to 0.

Data Encryption Type Flags

This set of flags allows a device to signal which “Data Encryption type” types are supported. This information can be used for diagnostic purposes. If a device fails to support the required attributes, then the user can be notified of this and given actionable instructs to correct the problem. In this example, the value of this field is a bitwise OR of one or more of the following values:
0x0001=WEP
0x0002=TKIP
0x0004=AES

Again, in this example, other values are reserved and set to 0.

Connection Type Flags

This set of flags allows a device to signal which “Connection type” types are supported. This information is used for diagnostic purposes. If a device fails to support the required attributes, then the user can be notified of this and given actionable instructs to correct the problem. The value of this field is a bitwise OR of one or more of the following values:
0x01=ESS (Extended Service Set)
0x02=IBSS (Independent Basic Service Set)

In this example, other values are reserved and are set to 0.

Based, at least in part, upon the handler 610's interaction with the service 650, the response component 630 generates information associated with an association response. Continuing with the Wi-Fi handler example, Table 11 identifies exemplary association response attributes. The lengths of the attributes in the attribute list in this example are fixed. Thus, device manufactures can easily jump to the appropriate offset to read the value of any given attribute in the response. Offsets refer to the start of the attribute.

TABLE 11

| | Attrib | | | |
|---|---|---|---|---|
| Attribute: | ID | Length | R/O | Allowed Values |
| SSID | 0x2001 | 32B | R | A string between 0 and 32 characters |
| (offset = x0013) | | | | in length, consisting of printable 8- |
| | | | | bit ASCII characters |
| SSID Length | 0x2002 | 1B | R | An integer value between 0-32 |
| (offset = x0034) | | | | representing the length of SSID |
| | | | | attribute in bytes. |
| Network Key | 0x2003 | 64B | R | A string of 5 to 64 8-bit ASCII chars |
| (offset = x0036) | | | | in length. More details are contained |
| | | | | in the Network Key attribute |
| | | | | description in section 5.6.2 |
| Network Key | 0x2004 | 1B | R | An integer value between 5-64 |
| Length | | | | representing the length of Network |
| (offset = x0077) | | | | Key attribute in bytes |
| Key Provided | 0x2005 | 1B | R | 0 for no, 1 for yes, must correspond with |
| Automatically | | | | authentication type, see |
| (802 1x) | | | | description for details |
| (offset = x0079) | | | | |
| Network | 0x2006 | 2B | R | These flags proscribe the Network |
| Authentication | | | | Auth types. Only one flag will be set |
| Type: | | | | at a time. |
| (offset = x007B) | | | | The response will be one of the |
| | | | | following values: |
| | | | | 0x0001 = Open |
| | | | | 0x0002 = WPAPSK |
| | | | | 0x0004 = Shared |
| | | | | 0x0008 = WPA |
| | | | | 0x0010 = WPA-NONE |
| | | | | 0x0020 = WPA2 |
| | | | | All other values are reserved and |
| | | | | shall be set to 0. |
| Data Encryption | 0x2007 | 2B | R | These flags proscribe the “Data |
| Type | | | | Encryption type.” Only one flag will |
| (offset = x007E) | | | | be set at a time. |
| | | | | The response will be one of the |
| | | | | following values: |
| | | | | 0x0001 = WEP |
| | | | | 0x0002 = TKIP |
| | | | | 0x0004 = AES |
| | | | | All other values are reserved and |
| | | | | shall be set to 0 |
| Connection Type | 0x2008 | 1B | R | These flags proscribe the |
| (offset = x0081) | | | | “Connection type.” Only one flag |
| | | | | will be set at a time |
| | | | | The response will be one of the |
| | | | | following values: |
| | | | | 0x01 = ESS |
| | | | | 0x02 = IBSS |
| | | | | All other values are reserved and |
| | | | | shall be set to 0 |

SSID

The SSID is a string used in broadcasting wireless networks, as discussed previously.

Network Key

The network key is a string used to secure the network. In this example, the following attributes are placed as constraints on the allowed values of the Network key. The Device will have to be prepared to accept or reject the following configurations:

TABLE 12

| Network | Data | |
|---|---|---|
| Auth | Auth | |
| Type | Type | Valid Network Key values |
| WPA | TKIP | 0-63 ASCII characters, |
| | | 64 HEX characters |
| WPA | AES | 0-63 ASCII characters, |
| | | 64 HEX characters |
| Open | WEP | 5 or 13 ASCII characters, |
| | | 10 or 26 HEX characters |

WEP Key

When the data auth type is WEP, the Network key is either an ASCII or HEX representation of a 40-bit or 104-bit WEP key. The type can be determined by the length of the string.

WPAPSK Pass Phrase

If the network key attribute is a 0-63 char ASCII string and the “network authentication type” attribute is WPA, the network key attribute is used as a pass phrase to derive the WPA binary key.

Key Provided Automatically (802.1x)

The “Key Provided Automatically (802.1x)” attribute dictates whether or not the Network Key is provided via 801.x This is typically set to 0 in cases where WPA-PSK, or WEP are used to secure the wireless network.

Network Authentication Type

The network authentication type indicates what type of security mechanism is required to join a particular network. The flag set specifies which of the following mechanisms is used:
0x0001=Open
0x0002=WPAPSK
0x0004=Shared
0x0008=WPA
0x0010=WPA-NONE
0x0020=WPA2

In this example, other values are reserved and are set to 0. Significantly, unlike the association request, these flags are mutually exclusive—only one flag can be set at a given time.

Data Encryption Type

This value specifies the encryption mechanism deployed by the wireless network. The flag set specifies which of the following mechanisms is used:
0x0001=WEP
0x0002=TKIP
0x0004=AES

All other values are reserved and are set to 0. Significantly, unlike the association request, these flags are mutually exclusive—only one flag can be set at a given time.

Connection Type

Connection type defines the type of wireless network. The flag set specifies which of the following mechanisms is used:
0x01=ESS
0x02=IBSS

All other values are reserved and are set to 0. These flags are mutually exclusive.

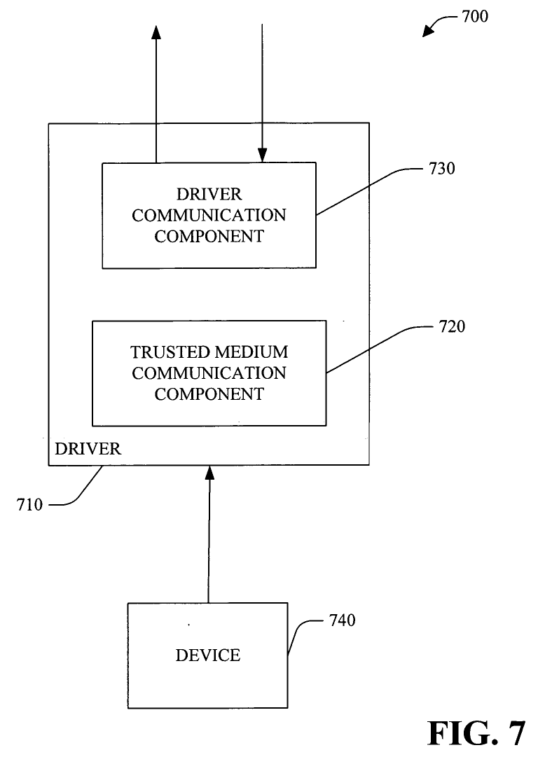

Turning next to FIG. 7, an association driver system 700 in accordance with an aspect of the subject invention is illustrated. The system 700 includes a driver 710 comprising a trusted media communication component 720 and a driver communication component 730.

The trusted medium communication component 720 interfaces with a device 740 via a trusted medium (e.g., USB connection). In one example, the trusted medium communication component 720 receives an association request from the device 740 (e.g., association request initiated time independent of device enumeration). In another example, the trusted medium communication component 720 receives notification of a request to issue an association request. Thereafter, the driver 710 generates an association request which is sent to an association manager (not shown) via the driver communication component 730.

In one example, driver(s) 710 implement the following interface:

TABLE 13

```
interface IPngDriver
{
      // Properties
      HRESULT Manager([in] IPngMgr* newVal);
      // Methods
      HRESULT Start( );
      HRESULT Stop( );
}
```

“Manager” is an interface pointer to the association manager so that the driver can call SendAssociationRequest. Start( ) is called by the association manager when it wishes for the driver to begin detecting and issuing new association requests. Stop( ) is called by the association manager when it whishes for the driver to stop issuing new association requests (e.g., when a user desires to disable association over a particular trusted medium).

In one example, a particular driver 710 can be related to a USB trusted medium. In this example, device(s) desiring to employ an untrusted medium send association request(s) and receive association response(s) securely through the driver 710.

For device(s) that implement dynamic association functionality, where association requests can be generated independent of device enumeration, in one example, there is an optional Interrupt IN endpoint. This endpoint facilitates notifications of new association requests. The standard endpoint descriptor for this optional endpoint can be found in Table 14:

TABLE 14

| Offset | Field | Size | Value | Description |
|---|---|---|---|---|
| 0 | bLength | 1 | 07h | Size of this descriptor in bytes |
| 1 | bDescriptorType | 1 | 05h | ENDPOINT descriptor type |
| 2 | bEndpointAddress | 1 | 81-8Fh | The address of this endpoint on the USB |
| | | | | device. This address is an endpoint |
| | | | | number between 1 and 15. |
| | | | | Bit 0..3 Endpoint number |
| | | | | Bit 4..6 Reserved, must be 0 |
| | | | | Bit 7 1 = In |
| 3 | bmAttributes | 1 | 03h | This is an Interrupt endpoint |
| 4 | wMaxPacketSize | 2 | 00??h | Maximum data transfer size |
| 6 | bInterval | 2 | ??h | Interval for polling endpoint for data |
| | | | | transfers. Expressed in milliseconds. Must |
| | | | | be in the range from 1 to 255. The |
| | | | | recommended value is 255. |

If a device's interface does not contain the optional endpoint, then association will only occur at enumeration time. If such a device wishes to initiate the association process, it will have to do a device initiated USB reset. This will cause the device to be re-enumerated by the host, at which point the host will retrieve the association request(s) from the device. In another example, a device can also implement HUB functionality to cause the association function to come and go as the device wishes.

Since the control endpoint is the only mandatory endpoint for a device that supports an association interface, the necessary data transfers happen over that endpoint. In this example, these transfers are in the form of association class requests.

Table 15 depicts a list of association class requests that must be supported by a device in one example.

TABLE 15

| Request | Value | Section |
|---|---|---|
| GET_ASSOCIATION_INFORMATION | 0x01 | 0 |
| GET_ASSOCIATION_REQUEST | 0x02 | 0 |
| SET_ASSOCIATION_RESPONSE | 0x03 | 0 |

GET_ASSOCIATION_INFORMATION

This request retrieves an association information structure from the device. The association information includes a list of REQUEST_INFO blocks. Each REQUEST_INFO block pertains to a single association request that the device wishes to issue:

TABLE 16

| | |
|---|---|
| bmRequestType | 10100001B |
| bRequest | GET_ASSOCIATION_INFORMATION |
| wValue | 0x0000 |
| wIndex | Interface |
| wLength | Length of requested Data |
| Data | ASSOCIATION_INFORMATION |

Table 17 illustrates an exemplary ASSOCIATION_INFORMATION structure:

TABLE 17

| Offset | Field | Size | Value | Description |
|---|---|---|---|---|
| 0 | PendingRequestCount | 1 | 0x00-0xff | Number of |
| | | | | pending |
| | | | | requests that |
| | | | | are listed at |
| | | | | the end of |
| | | | | this |
| | | | | structure |
| 1 | Flags | 2 | See table | See table 18 |
| | | | 18 for | for |
| | | | information | information |
| 3 | RequestInfoArray | Sizeof(REQUEST_INFO) | 0x000000-0xffffffff | Array of |
| | | * PendingRequestCount | | REQUEST_INFO |
| | | | | structures. |
| | | | | (See table 19) |

Table 18 provides exemplary Association Information Flag information:

TABLE 18

| | Flag | |
|---|---|---|
| Flag Name | Value | Description |
| AdditionalRequests | 0x0001 | If this flag is set, it indicates that the |
| | | device may have additional association |
| | | requests pending after the current set. |
| | | This being set results in the host sending |
| | | another |
| | | GET_ASSOCIATION_INFORMATION |
| | | after the current set of association |
| | | requests have been handled. They may |
| | | be useful for devices that have explicit |
| | | ordering concerns, or who may issue a |
| | | request as a result of a specific response. |
| | | If this is not set, it indicates to the host |
| | | that it does not need to issue another |
| | | GET_ASSOCIATION_INFORMATION |
| | | request. |

Table 19 illustrates an exemplary REQUEST_INFO structure:

TABLE 19

| Offset | Field | Size | Value | Description |
|---|---|---|---|---|
| 0 | RequestID | 1 | 0x00-0xff | This field identifies |
| | | | | a specific |
| | | | | association request. |
| | | | | This value will be |
| | | | | used to retrieve the |
| | | | | request and send the |
| | | | | response. |
| 1 | RequestSize | 4 | 0x00000000- | This is the size in |
| | | | 0xffffffff | bytes of the |
| | | | | particular |
| | | | | association request. |

GET_ASSOCIATION_REQUEST

This request retrieves a particular association request from the device. The request is identified by the RequestID value in the wValue field:

TABLE 20

| | |
|---|---|
| bmRequestType | 10100001B |
| bRequest | GET_ASSOCIATION_REQUEST |
| wValue | RequestID BlockNumber |
| wIndex | Interface |
| wLength | Length of requested Data |
| Data | Association Request |

In this example, a request block is a 4 KB block of data. The maximum transfer size of a control transfer is 64 KB, so 16 request blocks can be theoretically transferred in each GET_ASSOCIATION_REQUEST. The actual amount of data to be transferred is specified by the wLength field. The BlockNumber specified in the wValue field identifies the starting block number for this control transfer. So, in this example, the device 540 should return association request data for the request specified by RequestID starting at offset BlockNumber * 4 KB, and transferring wLength bytes.

SET_ASSOCIATION_RESPONSE

This request sends a response to a specific association request identified by the RequestID value in the wValue field:

TABLE 21

| | |
|---|---|
| bmRequestType | 00100001B |
| bRequest | SET_ASSOCIATION_RESPONSE |
| wValue | RequestID TransferFlags |
| wIndex | Interface |
| wLength | Length of response Data |
| Data | Association Response |

In this example, the TrasferFlags value is the bitwise OR of zero or more of the values found in Table 22:

TABLE 22

| Flag Name | Flag Value | Description |
|---|---|---|
| LastBlock | 0x01 | If this flag is set, it indicates that this |
| | | is the last control transfer that |
| | | contains data for this specific |
| | | Association Response. This |
| | | facilitates chaining of control |
| | | transfers for large responses. |

Association Interrupt-In Message(s)

NewAssociationRequest

This interrupt IN message indicates to the host that the device has new or modified association request(s) that need to be processed. Upon receiving this message, the host can issue a GET_ASSOCIATION_INFORMATION request, and process the requests accordingly.

TABLE 23

| Offset | Field | Size | Value | Description |
|---|---|---|---|---|
| 0 | bMessageType | 1 | 50 h | New association request event |
| 1 | bRequestCount | 1 | 0x00-0xff | Number of pending requests that may be |
| | | | | returned in a subsequent |
| | | | | GET_ASSOCIATION_INFORMATION. |
| | | | | This field is really a hint to the host to |
| | | | | determine how large of a buffer it needs |
| | | | | to allocate in order to receive the |
| | | | | association information. |

It is to be appreciated that the system 100, device 110, association manager 120, handler 130, driver 140, handler registry 150, driver registry 160, system 400, association manager 410, manager communication component 420, handler identification component 430, association manager 510, initialization component 520, system 600, handler 610, request component 620, response component 630, association processor 640, service 650, system 700, driver 710, trusted medium communication component 720, driver communication component 730 and/or the device 740 can be computer components as that term is defined herein.

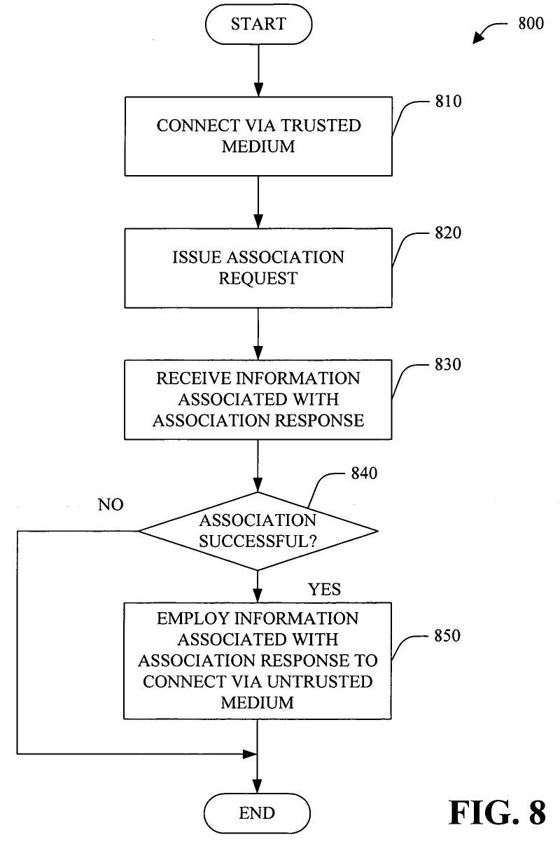

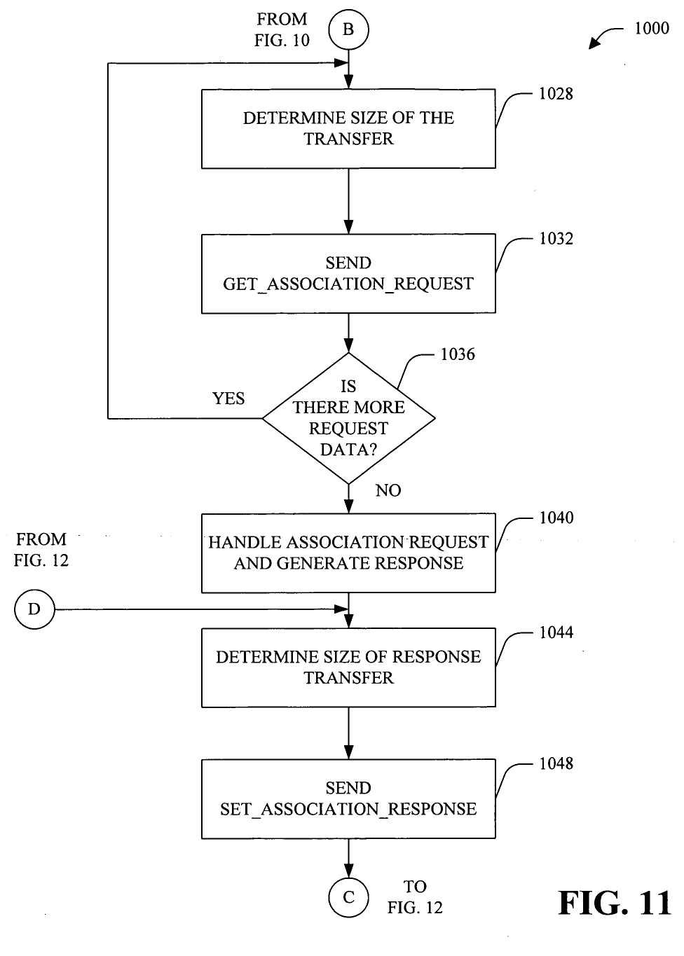

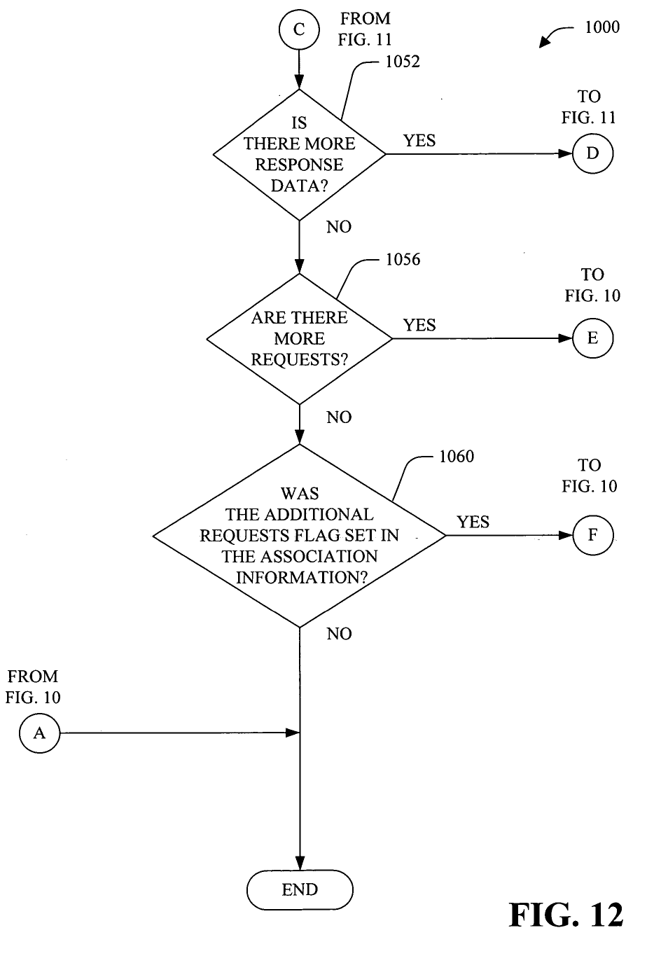

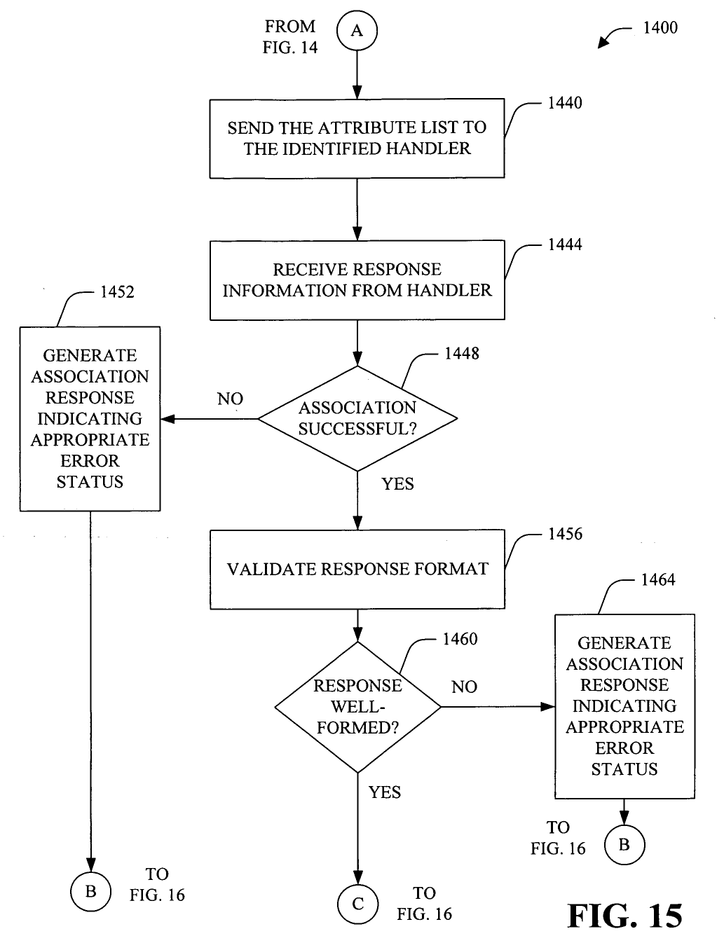

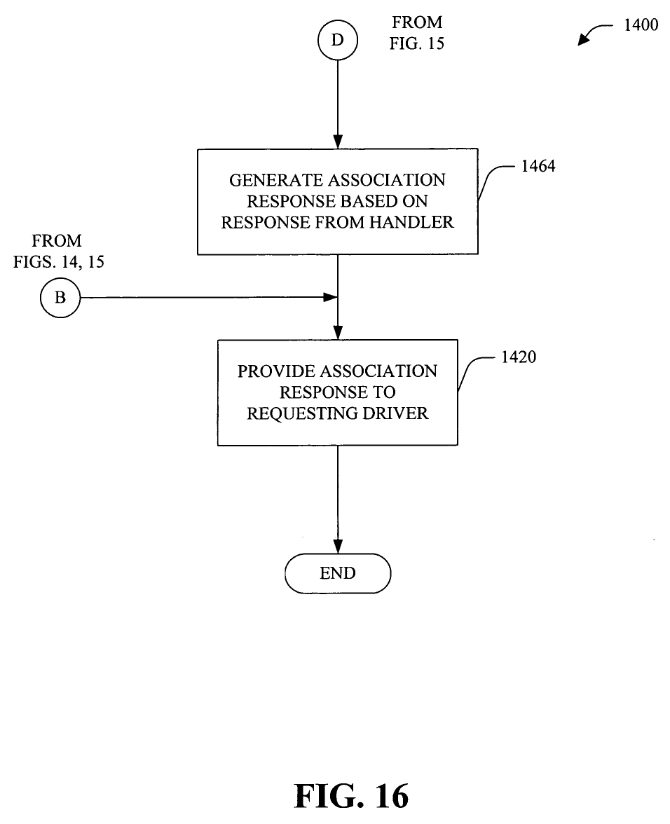

Turning briefly to FIGS. 8-18, methodologies that may be implemented in accordance with the subject invention are illustrated. While, for purposes of simplicity of explanation, the methodologies are shown and described as a series of blocks, it is to be understood and appreciated that the subject invention is not limited by the order of the blocks, as some blocks may, in accordance with the subject invention, occur in different orders and/or concurrently with other blocks from that shown and described herein. Moreover, not all illustrated blocks may be required to implement the methodologies in accordance with the subject invention.

The subject invention may be described in the general context of computer-executable instructions, such as program modules, executed by one or more components. Generally, program modules include routines, programs, objects, data structures, etc. that perform particular tasks or implement particular abstract data types. Typically the functionality of the program modules may be combined or distributed as desired in various embodiments.

Referring to FIG. 8, a method of associating a device 800 in accordance with an aspect of the subject invention is illustrated. At 810, a connection (e.g., of a device) is established via a trusted medium (e.g., USB). At 820, an association request is issued, for example, by the device and/or an associated driver. At 830, information associated with an association response is received (e.g., from a driver). The information can include, for example, the association response received from an association manager. Alternatively, the information can include a portion of the association response received from the association manager.

At 840, a determination is made as to whether the association was successful. If the determination at 840 is NO, no further processing occurs. If the determination at 840 is YES, at 850, information associated with the association response is employed to connect (e.g., the device) via an untrusted medium (e.g., wireless connection).

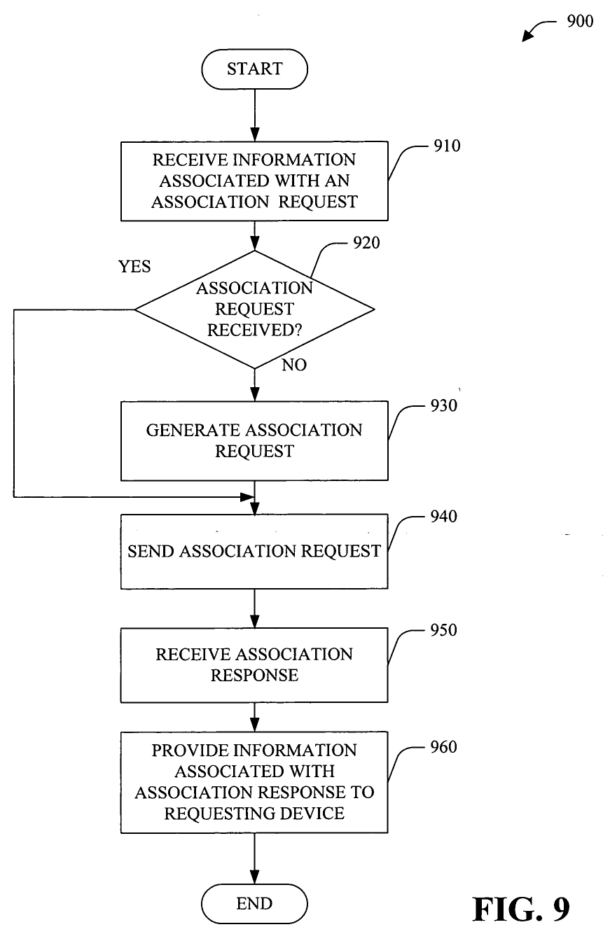

Turning next to FIG. 9, a method facilitating association of a device 900 in accordance with an aspect of the subject invention is illustrated. At 910, information associated with an association request is received. At 920, a determination is made as to whether an association request was received. If the determination at 920 is NO, at 930, the association request is generated, and, processing continues at 940. If the determination at 920 is YES, at 940, the received association request is sent, for example, to an association manager.

At 950, an association response is received, for example, from the association manager. At 960, information associated with the association response is provided to the requesting device. For example, the information can include the entire association response and/or a portion of the association response. Thereafter, no further processing occurs.

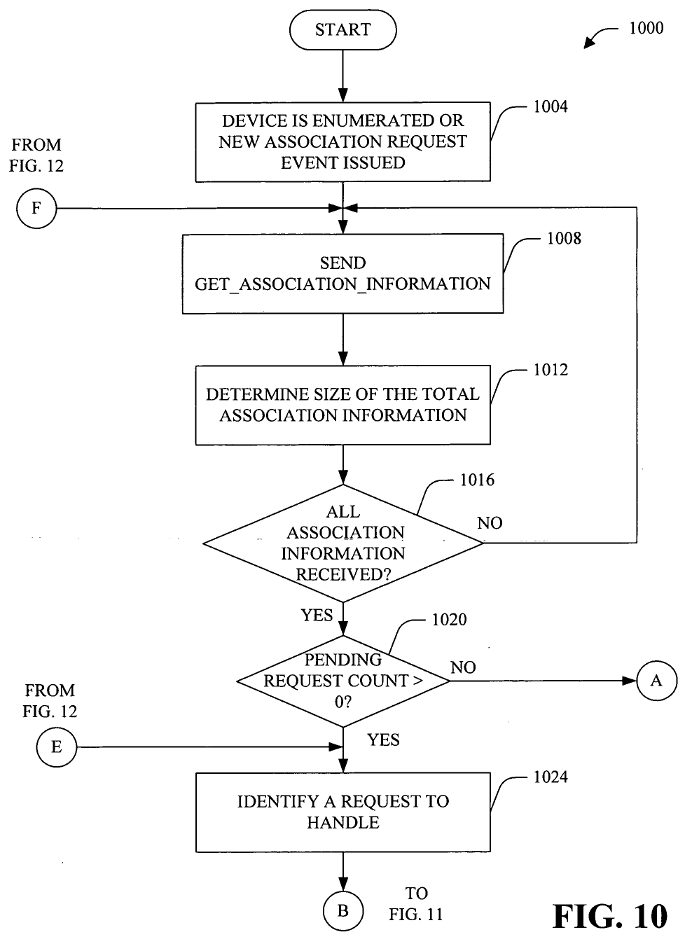

Next, referring to FIGS. 10-12, a method of associating a device via a USB connection 1000 in accordance with an aspect of the subject invention is illustrated. At 1004, a device is enumerated and/or a new association request event is issued. At 1008, a GET_ASSOCIATION_INFORMATION request is sent to the device, for example, by a driver. At 1012, a size of the total association information is determined, for example, by the driver (e.g., size=3+sizeof (REQUEST_INFO)* PendingRequestCount).

At 1016, a determination is made as to whether substantially all of the association information has been received, for example, by the driver. If the determination at 1016 is NO, processing continues at 1008. If the determination at 1016 is YES, at 1020, a determination is made as to whether PendingRequestCount is greater than zero. If the determination at 1020 is NO, no further processing occurs.

If the determination at 1020 is YES, at 1024, a request is identified to handle (e.g., by the driver). At 1028, the size of the transfer (e.g., association request) is determined. At 1032, a GET_ASSOCIATION_REQUEST is sent. At 1036, a determination is made as to whether there is more request data. If the determination at 1036 is YES, process continues at 1028. If the determination at 1036 is NO, at 1040, the association requested is handled and an association response is generated (e.g., by an association manager and/or handler).

At 1040, the size of the association response transfer is determined. At 1048, a SET_ASSOCIATION_RESPONSE is sent. At 1052, a determination is made as to whether there is more response data. If the determination at 1052 is YES, processing continues at 1044. If the determination at 1052 is NO, at 1056, a determination is made as to whether there are more requests.

If the determination at 1056 is YES, processing continues at 1024. If the determination at 1056 is NO, at 1060 a determination is made as to whether an additional requests flag has been sent in the association information. If the determination at 1060 is YES, processing continues at 1008. If the determination at 1060 is NO, no further processing occurs.

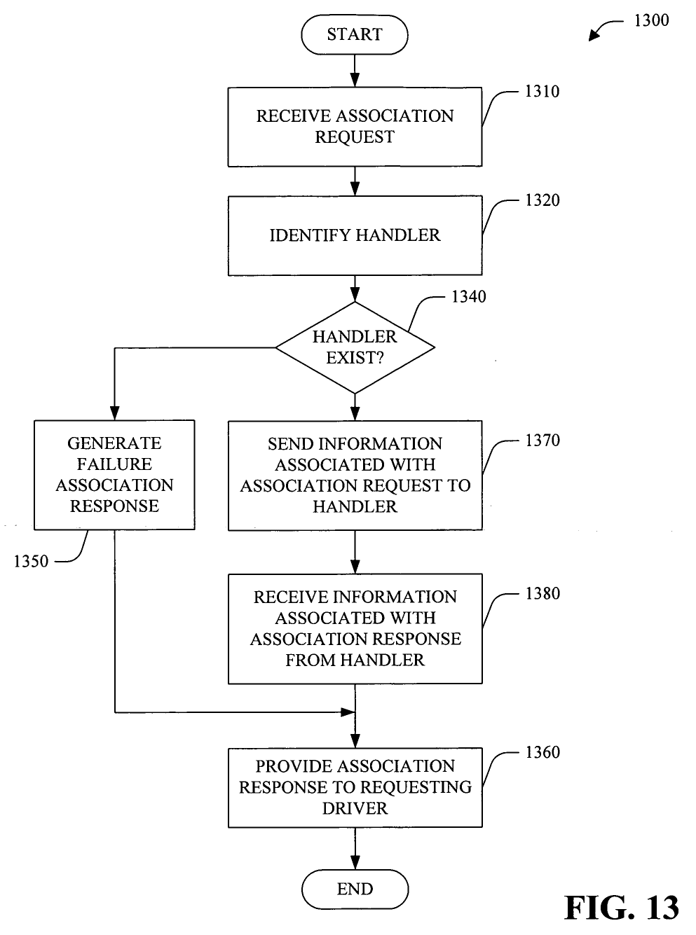

Referring next to FIG. 13, an association management method 1300 in accordance with an aspect of the subject invention is illustrated. At 1310, an association request is received, for example, from a driver. At 1320, a handler for the association request is identified. At 1340, a determination is made as to whether a handler exists for the association request. If the determination at 1340 is NO, at 1350, a failure of association response is generated, and, processing continues at 1360.

If the determination at 1340 is YES, at 1370, information associated with the association request is sent to the handler. For example, the information can comprise the association request and/or a portion of the association request (e.g., attribute list(s)).

At 1380, information associated with an association response is received from the handler. At 1360, an association response is provided to the requesting driver.

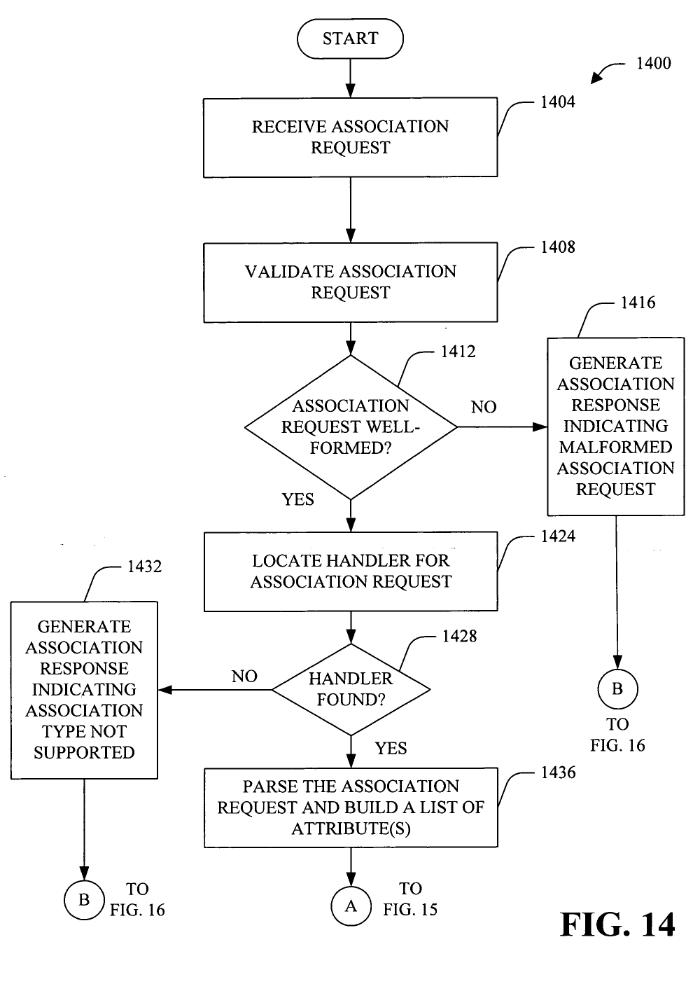

Turning to FIGS. 14-16, an association management method 1400 in accordance with an aspect of the subject invention is illustrated. At 1404, an association request is received, for example, from a driver. At 1408, the association request is validated. At 1412, a determination is made as to whether the association request is well-formed. If the determination at 1412 is NO, at 1416, an association response indicating malformed association request is generated, and, processing continues at 1420.

If the determination at 1412 is YES, at 1424, a handler for the association request is located. At 1428, a determination is made as to whether a handler has been found. If the determination at 1428 is NO, at 1432, an association response indicating association type not supported is generated, and, processing continues at 1420.

If the determination at 1428 is YES, at 1436, the association request is parsed and a list of attribute(s) is built. At 1440, the attribute list is sent to the identified handler. At 1444, response information is received from the handler. At 1448, a determination is made as to whether the association was successful. If the determination at 1448 is NO, at 1452, an association response is generated indicating an appropriate error status, and, processing continues at 1420.

If the determination at 1448 is YES, at 1456, the response format is validated. At 1460, a determination is made as to whether the response is well-formed. If the determination at 1460 is NO, at 1464, an association response indicating an appropriate error status is generated, and, processing continues at 1420.

If the determination at 1460 is YES, at 1468, an association response is generated based on the response from the handler. At 1420, the association response is provided to the requesting driver, and, no further processing occurs.

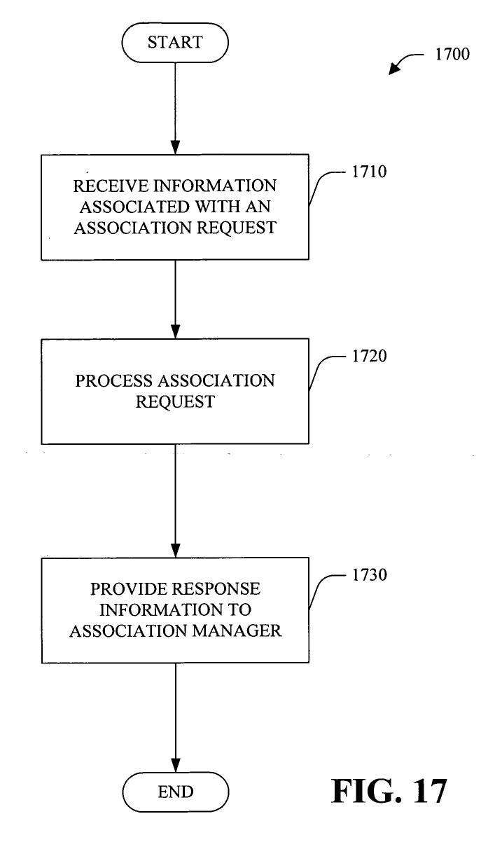

Referring to FIG. 17, an association handler method 1700 in accordance with an aspect of the subject invention is illustrated. At 1710, information associated with an association request (e.g., attribute list) is received, for example, an association manager. At 1720, the association request is processed. At 1730, response information is provided to the association manager.

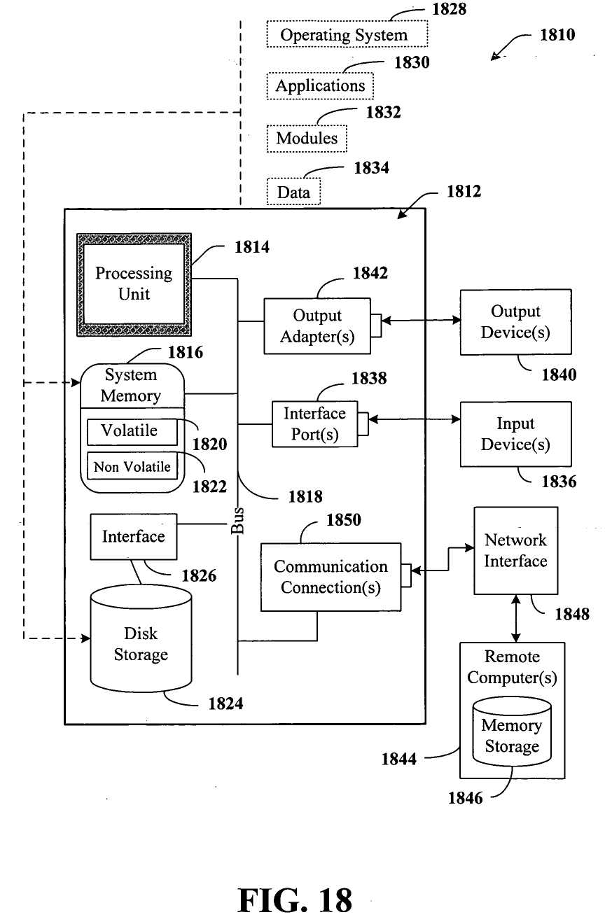

In order to provide additional context for various aspects of the subject invention, FIG. 18 and the following discussion are intended to provide a brief, general description of a suitable operating environment 1810 in which various aspects of the subject invention may be implemented. While the subject invention is described in the general context of computer-executable instructions, such as program modules, executed by one or more computers or other devices, those skilled in the art will recognize that the subject invention can also be implemented in combination with other program modules and/or as a combination of hardware and software. Generally, however, program modules include routines, programs, objects, components, data structures, etc. that perform particular tasks or implement particular data types. The operating environment 1810 is only one example of a suitable operating environment and is not intended to suggest any limitation as to the scope of use or functionality of the subject invention. Other well known computer systems, environments, and/or configurations that may be suitable for use with the subject invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 18, an exemplary environment 1810 for implementing various aspects of the subject invention includes a computer 1812. The computer 1812 includes a processing unit 1814, a system memory 1816, and a system bus 1818. The system bus 1818 couples system components including, but not limited to, the system memory 1816 to the processing unit 1814. The processing unit 1814 can be any of various available processors. Dual microprocessors and other multiprocessor architectures also can be employed as the processing unit 1814.

The system bus 1818 can be any of several types of bus structure(s) including the memory bus or memory controller, a peripheral bus or external bus, and/or a local bus using any variety of available bus architectures including, but not limited to, an 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1816 includes volatile memory 1820 and nonvolatile memory 1822. The basic input/output system (BIOS), containing the basic routines to transfer information between elements within the computer 1812, such as during start-up, is stored in nonvolatile memory 1822. By way of illustration, and not limitation, nonvolatile memory 1822 can include read only memory (ROM), programmable ROM (PROM), electrically programmable ROM (EPROM), electrically erasable ROM (EEPROM), or flash memory. Volatile memory 1820 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1812 also includes removable/nonremovable, volatile/nonvolatile computer storage media. FIG. 18 illustrates, for example a disk storage 1824. Disk storage 1824 includes, but is not limited to, devices like a magnetic disk drive, floppy disk drive, tape drive, Jaz drive, Zip drive, LS-100 drive, flash memory card, or memory stick. In addition, disk storage 1824 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1824 to the system bus 1818, a removable or non-removable interface is typically used such as interface 1826.

It is to be appreciated that FIG. 18 describes software that acts as an intermediary between users and the basic computer resources described in suitable operating environment 1810. Such software includes an operating system 1828. Operating system 1828, which can be stored on disk storage 1824, acts to control and allocate resources of the computer system 1812. System applications 1830 take advantage of the management of resources by operating system 1828 through program modules 1832 and program data 1834 stored either in system memory 1816 or on disk storage 1824. It is to be appreciated that the subject invention can be implemented with various operating systems or combinations of operating systems.

A user enters commands or information into the computer 1812 through input device(s) 1836. Input devices 1836 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1814 through the system bus 1818 via interface port(s) 1838. Interface port(s) 1838 include, for example, a serial port, a parallel port, a game port, and a universal serial bus (USB). Output device(s) 1840 use some of the same type of ports as input device(s) 1836. Thus, for example, a USB port may be used to provide input to computer 1812, and to output information from computer 1812 to an output device 1840. Output adapter 1842 is provided to illustrate that there are some output devices 1840 like monitors, speakers, and printers among other output devices 1840 that require special adapters. The output adapters 1842 include, by way of illustration and not limitation, video and sound cards that provide a means of connection between the output device 1840 and the system bus 1818. It should be noted that other devices and/or systems of devices provide both input and output capabilities such as remote computer(s) 1844.

Computer 1812 can operate in a networked environment using logical connections to one or more remote computers, such as remote computer(s) 1844. The remote computer(s) 1844 can be a personal computer, a server, a router, a network PC, a workstation, a microprocessor based appliance, a peer device or other common network node and the like, and typically includes many or all of the elements described relative to computer 1812. For purposes of brevity, only a memory storage device 1846 is illustrated with remote computer(s) 1844. Remote computer(s) 1844 is logically connected to computer 1812 through a network interface 1848 and then physically connected via communication connection 1850. Network interface 1848 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1850 refers to the hardware/software employed to connect the network interface 1848 to the bus 1818. While communication connection 1850 is shown for illustrative clarity inside computer 1812, it can also be external to computer 1812. The hardware/software necessary for connection to the network interface 1848 includes, for exemplary purposes only, internal and external technologies such as, modems including regular telephone grade modems, cable modems and DSL modems, ISDN adapters, and Ethernet cards.

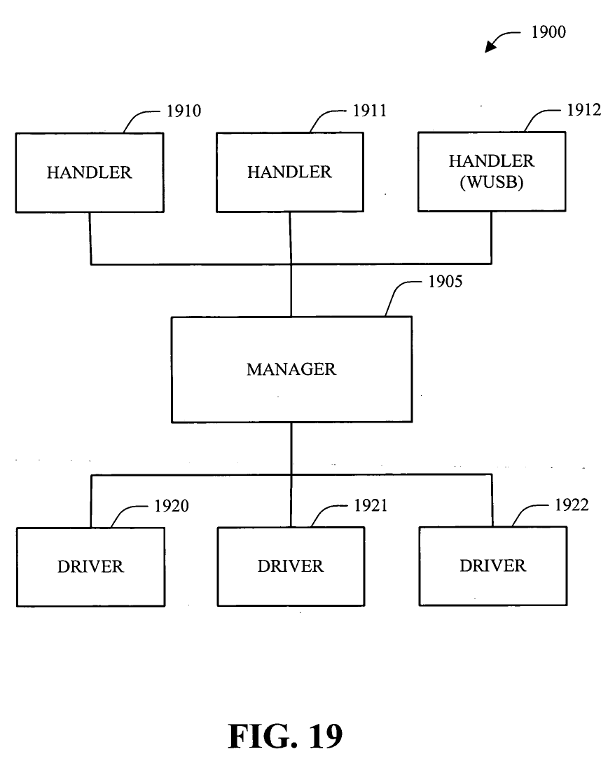

In an example embodiment, the extensible architecture may be implemented as a Plug and Go (PONG) architecture that includes wireless universal serial bus (WUSB) support. FIG. 19 shows an example of a PONG system 1900. Manager 1905 is the central component configured to facilitate passing data to the correct parties. Manager 1905 may load driver data, (such as dlls) into a process. For example, Manager 1905 may load the driver data based on driver registration. When Manager 1905 receives a request block from a driver, it may look at the request block header and may load the appropriate handler for that request type. Handlers or the drivers may be loaded at system startup. The request block is given to the handler for processing. Once the handler is finished, a response block is returned to the driver through manager 1905.

Drivers 1920-1922 are responsible for interfacing with either some form of hardware, or another software component. Drivers 1920-1922 are responsible for channeling requests from manager 1905 to devices over the trusted medium.

Each of the drivers 1920-1922 may detect when a new request should be issued, and it either retrieves or generates the request. This request is passed to manager 1905, who will later return a response to the driver.

Multiple handlers can use the same driver (i.e. multiple target medium can use the same trusted medium). Drivers 1920-1922 may not require any knowledge of the details of the request block or the response block.

Handlers 1910-1912 are responsible for interfacing with the service that implements device installation/association. Handlers 1910-1912 may be directly related to the target medium and may be the only component that needs to have explicit knowledge of the attributes in the request block for that specific target medium. There are global attributes that can be used by other components also.

Handlers 1910-1912 may be configured to handle any type of target medium, such as a wireless medium. As shown in FIG. 19, handler 1912 is configured to handle a WUSB medium. WUSB is the wireless protocol defined by the USB Implementers Form (USB-IF) for connect wireless USB peripherals to wireless USB hosts. WUSB protocol is specified to work over the Multiband OFDM Alliance (MBOA) media access control (MAC) layer on top of ultra wide band (UWB). When any one of the handlers 1910-1912 receives the Request Block from Manager 1905, the handler will parse the contents to determine the appropriate action.

The PONG system 1900 enables devices to send requests and responses that include attributes associated with WUSB. For a request passed from the device to the handler, an attribute list may include association type, connection device ID, connection key, device setup class GUID, supported band groups, integrator site URL, or the like. The association type is an attribute contained in the header section of the request and response, and is separate from data attributes. The association type attribute is used by a manager to forward requests to the correct handler. Table 24 shows an example specification of an association type attribute.

TABLE 24

| Attribute | Attribute | | | |
|---|---|---|---|---|
| name: | ID: | Length | M/O | Allowed Values |
| Association | 0x0000 | 16 B | M | 59ACFDCB-153E-41ef-8111- |
| type | | | | FA19CFE42B1E |

The terms in Table 24 and the tables below are defined as:

Attribute name: The friendly name associated with an attribute element.

Attribute ID: This number is used to identify the attribute element in the attribute list.

Length: The length of the data in an attribute element. Attribute lengths can be varied or fixed and are expressed in bytes. A length value may also specify a maximum length. In the response, fixed lengths are used so that the offset to the value is deterministic, aiding the ability of a device to parse the response. The actual value of the attribute may not use up the entire length allocated for the data. In these cases, an additional field specifies the actual length of the attributes data.

M/O: This field conveys whether a variable is mandatory or optional. Mandatory attribute elements will always be contained in a list of attributes. Optional value will not necessarily be present. “Mandatory” and “Optional” are expressed with an M or 0.

Allowed Values: The allowed values field describes the values to be supported by the device. If an allowed value is required, it means the device supports that value if it is contained in the attribute list. Unless otherwise stated in the table, values should be assumed to be required. If an allowed value is optional, the device need not support the value, but should be prepared for it to be contained in the attribute list. Optional values may become required in future versions of this specification

The data section of a request may contain attributes that are specific to the attribute type. Table 25 shows example request attributes that may be forwarded to a WUSB handler:

TABLE 25

| Attribute | | | | |
|---|---|---|---|---|
| name: | Attribute ID: | Length | M/O | Allowed Values |
| Connection | 0x1000 | 16 B | O | A 128 bit unique device ID. This |
| Device ID | | | | ID uniquely identifies the device |
| (CDID) | | | | to the host. If attribute is missing, |
| | | | | or the value is all zeros, then the |
| | | | | Device ID will be supplied by the |
| | | | | host in the Association Response. |
| Connection | 0x1001 | 16 B | O | A 128 bit key to be used to |
| Key (CK) | | | | establish reconnections. If this |
| | | | | attribute is missing, or the value is |
| | | | | all zeros, then the Connection |
| | | | | Key will be supplied by the host |
| | | | | in the Association Response. |
| Device Setup | 0x1002 | 16 B | O | This GUID represents the class of |
| Class GUID | | | | device as utilized in infs. |
| Supported | 0x1003 | 2 B | O | A 2 byte bit-mask which reports |
| Band Groups | | | | which UWB band groups are |
| | | | | supported by the device. |
| Integrator Site | 0x1004 | Variable | O | URL pointing to specific location |
| URL | | | | containing device's details on the |
| | | | | USB-IF certified devices integrator's list. |

Connection Device ID (CDID) is the device ID of the wireless USB device. If the device had previously been assigned a device ID (whether from the factory, a previous association attempt, user input, etc), it may wish to utilize the same ID. By reusing an existing ID, then a host may behave differently knowing that it has seen the device before. It may also make it easier for devices which can be associated with multiple hosts simultaneously. For example, CDID can be sent by the device if the device wishes to preserve the same CDID across multiple hosts, or to indicate that it has already been associated with this host. The host can either overwrite this value, or it can reuse this value.

If this attribute is missing, or the value is all zeros, then the host will assume that the device requires a new device ID. The host will generate this unique ID and return it to the device in the association response.

Connection Key (CK) is the key which will be used to facilitate mutual authentication and to generate session encryption keys as described in the WUSB specification. CK can be sent by the device if the device needed to have a hard-coded connection key. A device may wish to include this attribute in the request if it has the inability to store a generated key (no NVRAM). It is not recommended, however, for devices to hardcode these keys, but rather they should allow the host to dynamically generate them for better security.

If this attribute is missing, or the value is all zeros, then the host will assume that the device requires a CK to be generated and will return the CK in the association response.

Device Setup Class GUID is one of the supported setup class GUIDs. Providing this value in the association request allows the display of appropriate icons for the device, or to implement some system or user defined policy. This value may be used to determine what type of device is being associated. GUID can be used to match against an installed device setup class on the host to determine things such as icons, descriptions, etc. This will also help display appropriate information in any UI to help the user identify the particular device.

Supported Band Groups may be used to determine which channels the host radio should choose from when picking a channel. For example, supported Band Groups can be used by the host to determine what PHY channels it can use. Without this information from the device, the host would be required to change to a channel in band group 1 since that is the only band group that is required to be supported by all devices. This would lead to all hosts and devices choosing to use band group 1, thus crowding the channels, and diminishing the value of the other band groups. If this information is communicated to the host at association time, the host will know the supported channels for all devices which may possibly connect to the host, thus allowing the host to possibly choose channels in other band groups.

A 1 in a bit position indicates all of the bands and channels in the associated PHY bandgroup are supported. A 1 in bit position 0 indicates that all bands in band group one are supported.

Integrator Site URL can be used in UI to provide information to the user about the device by providing the link to the device's details on the USB-IF website.

Table 26 shows example response attributes that may be forwarded to a WUSB device. The example offsets are shown in the table. Also, the header attributes may be accounted for the first 19 bytes of the attribute list.

TABLE 26

| Attribute | | | | |
|---|---|---|---|---|
| name: | Attribute ID: | Length | M/O | Allowed Values |
| Connection | 0x2000 | 16B | M | A 128 bit unique host ID. This |
| Host ID | | | | ID uniquely identifies the host to |
| (CHID) | | | | the device. |
| (offset=0x13) | | | | |
| Connection | 0x1000 | 16B | M | A 128 bit unique device ID. This |
| Device ID | | | | ID uniquely identifies the device |
| (CDID) | | | | to the host. If the device specified |
| (offset=0x23) | | | | this attribute in the Association |
| | | | | Request, then this value will be |
| | | | | identical. |
| Connection | 0x1001 | 16B | M | A 128 bit key to be used to |
| Key (CK) | | | | establish reconnections. If the |
| (offset=0x33) | | | | device specified this attribute in |
| | | | | the Association Request, then this |
| | | | | value will be identical. |
| Preferred | 0x2001 | 16B | O | This will indicate channel |
| Channels | | | | selection priority that the host will use |
| | | | | when selecting channels. |
| | | | | With this information, a device |
| | | | | can change the order of channels |
| | | | | to scan when looking for the host |
| | | | | in order to minimize search time |
| | | | | by first scanning preferred |
| | | | | channels. |
| Host Region | 0x2002 | 16B | O | An indication from the host to tell |
| | | | | the device which region it is |
| | | | | operating in. This may be |
| | | | | necessary if different countries or |
| | | | | region specify different |
| | | | | operational restrictions on device |
| | | | | with respect to power, range, |
| | | | | frequency, etc. |

For responses pass from the handler to the device, an attribute list may include connection host ID, connection device ID, connection key, preferred channels, host region, or the like. Connection Host ID (CHID) is the unique host ID. The device can use this ID to locate the host's beacon, thereby locating the host. Connection Device ID (CDID) is the unique device ID. This ID uniquely identifies the device to the host specified by CHID. It is not guaranteed to be unique across multiple hosts. Connection Key (CK) is for establishing reconnections using this context. The CK may be a 128-bit CCM key.

Preferred Channels can be specified in the host response in order to inform the device of the preferred channel order that the host is using. This can optimize the process of searching for the host by giving the device hints about the relative likelihood that the host would be on any given channel. The device can search for the host in the order that the host specified, thus making it more likely that the device would find the host on one of the first few channels scanned, rather than scanning in a linear order.

Host Region can be specified in the host response in order to notify the device about what region it is operating in. The device can use this information to change its radio operational properties to region specific values.

In one embodiment, the lengths of the attributes in the attribute list may be fixed. Thus, device manufactures can easily jump to the appropriate offset to read the value of any given attribute in the response. Offsets refer to the start of the attribute.

Other attributes may be used for requests and responses between devices and handlers. These other attributes may include hardware and compatible ID, channel ID, band group, device manufacturer string, device description string, host string, class of device GUID, manufacturer URL, device Icon, association secret key, or the like. Association secret key is a PONG specific key written to a device. The device typically would not reveal the association secret key, except through PONG. The next time that the device attaches, the association secret key is retrieved and is used to authenticate the device. The use of association secret key may enable performing tasks, such as silently updating the association information without asking the user, allowing the device to retain its CDID, or the like. Without using the association key, it may be possible for two devices with the same CDID (e.g. obtained from another host, stolen from another device, or the like) to affect the ability for the devices to connect to the PC.

Following are two example scenarios that can be achieved using the architecture and WUSB connection mechanisms described above:

Scenario 1-WUSB Portable Player with PC:

Todd gets a new wired+wireless USB portable player that worked with Windows Media Player to synchronize. On opening the box, he removes the player and adds the included recharable batteries to the player. He then follows the instructions to install 3rd party software and then attach the player to the PC using the wired USB cable to charge the batteries. While charging the batteries, the player is also bonded to the PC for Wireless USB connectivity and even initiates device synchronization over wired USB.

Once the cable is unplugged and the device is within range, the user should not see any new dialogs for wireless USB device detection and the device should just start working.

Scenario 2-Cell Phone and Storage with PC:

Jack has a PC and a WUSB storage device that are preassociated. When Jack associates his WUSB cell phone with the PC, he gets the option to also associate the other WUSB devices (that may have 1 free connection slot) with the cell phone. This increases the value of the PC and simplifies the end users connection experience.

4 example association models for associating a WUSB device are included below for illustration:

UI Approach—Use a connect button (once devices are in proximity) on both systems and identify the device from a UI list of pairable devices within proximity.

Serial # Approach—This is very similar to the UI approach but once the user has identified the device from the UI, the user has to type in a serial number from the device on to the host, to enable security.

USB Cable Approach—Use a generic USB cable to plug in the wireless USB device into the host that you want to associate with. The wire can be used for regular operation or charging along with association.

USB Flash Key—Use a generic USB Mass Storage device (e.g. a USB Flash Device) to store and exchange identification and security information between the device and host.

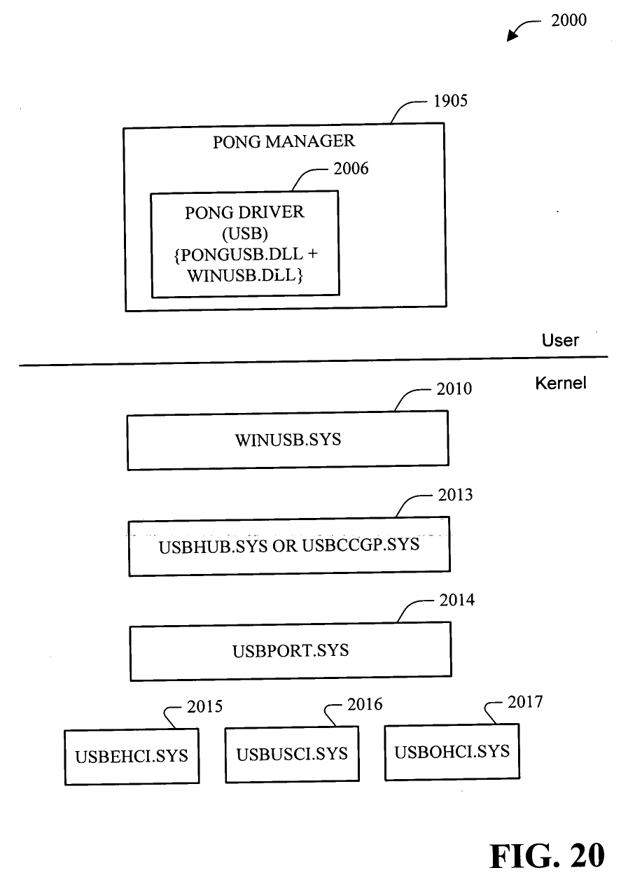

PONG system 1900 shown in FIG. 19 may be specifically configured to support USB. FIG. 20 shows an example USB driver stack 2000 for a device manager architecture of an operating system. Driver stack 2000 may be implemented to support USB as a trusted medium in PONG system 1900. Components 2013-2017 are the existing USB stack of the operating system. Component 2010 is the kernel component of the PONG USB driver. Component 2006 is the user mode PONG driver encapsulated by the overall PONG manager 1905.

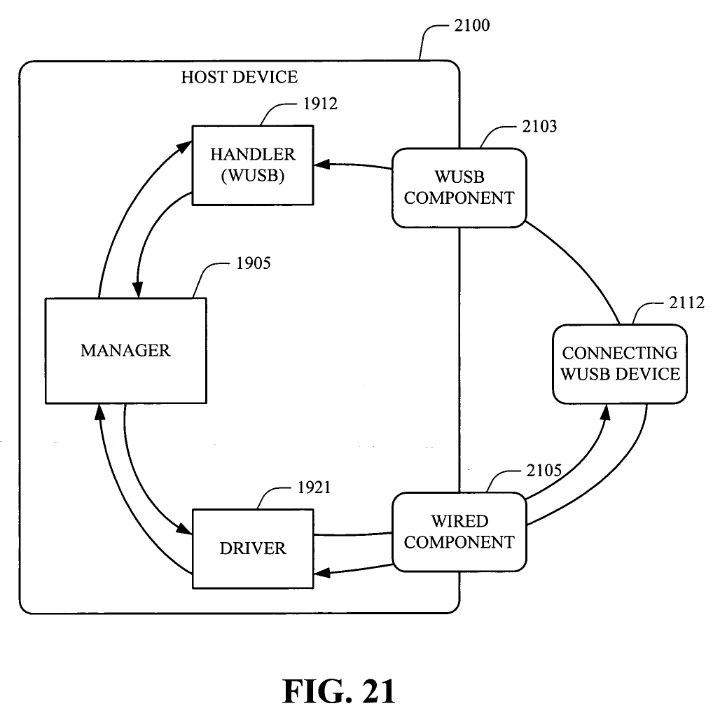

FIG. 21 shows example operations for a WUSB device 2112 to connect to a host device 2100. Connecting WUSB device 2112 can be any device that is capable of communicating using WUSB. Typically, connecting WUSB device 2112 is also capable of communication using a trusted medium. As discussed above, trusted medium may include wired connections, such as wired USB, serial, parallel, firewire, Ethernet, or the like. Trusted medium may also include wireless connections, such as near field communication (NFC), infrared (IR), or other established wireless connections. Host device 2100 includes manager 1905, WUSB handler 1912 and driver 1912 as discussed above in conjunction with FIG. 19. As shown in FIG. 21, host device 2100 also includes WUSB component 2103 for connecting to external devices using WUSB and wired component 2105 for connecting to devices using a wired connection.

To connect to host device 2100, connecting WUSB device sends a request to driver 1921 through wired component 2105. For example, connecting WUSB device 2112 may be connected to wired component 2105 through a wire USB cable. The request includes information for associating WUSB device 2112 with host device 2100, such as the attributes discussed above.

Driver 1921 sends the request to manager 1905, which parses and validates the information in the request. In particular, manager 1905 may determine the type of connection in the request and whether the information in the request is valid for the standard related to the connection. In this example, manager 1905 determines that the request is associated with a WUSB connection. Manager 1905 validates the device attributes in the request. If the request is valid, manager 1905 provides the WUSB connection information, such as device attributes, to WUSB handler 1912.

WUSB handler 1912 processes the connection information and provides host connection information to manager 1905 in response to the request. The host connection information includes connection attributes that are used to connect using WUSB. Manager 1905 provides the host connection information with the connection attributes to driver 1921, which sends the connection information to connecting WUSB device 2112 through wired component 2105. Connecting WUSB device 2112 then uses the connection information for self-configuring and connecting to host device 2100. For example, connecting WUSB device 2112 may adjust the WUSB component to the configuration required by host device 2100, such as channel, region, or the like. Connecting WUSB device 2112 may also send information to host device 2100 with a key, a host ID and a device ID identified in the received connection information.

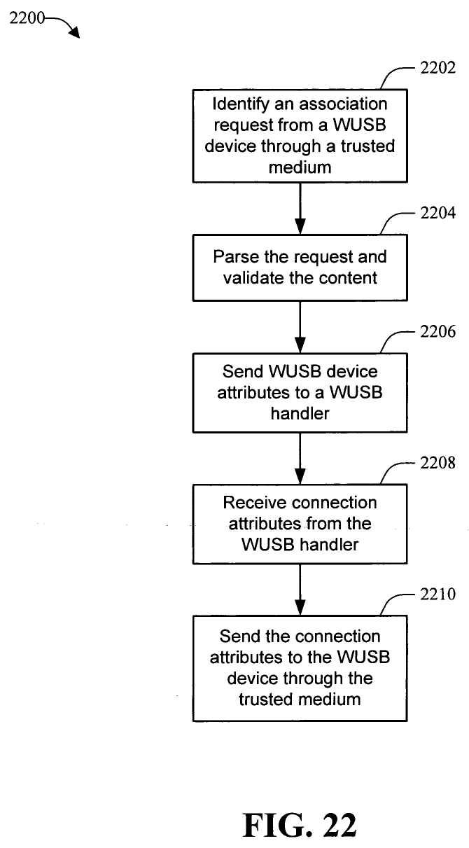

FIG. 22 shows an example process 2200 for connecting a WUSB device with a host device using the system described herein. For example, process 2200 may be implemented by manager 1902. At block 2202, an association request from a WUSB device is identified. The association request may be received through a trust medium, such as a wired medium. At block 2204, the request is parsed and the content is validated. Parsing the request allows the determination of the type of association that is included in the request. The request is validated based on the standard corresponding to the type. In this example, the type of the association is WUSB and the request is validated against the WUSB standard. The validated request should include device attributes that are specified by the WUSB standard.

At block 2206, the WUSB device attributes are sent to a WUSB handler. At bock 2208, connection attributes are received from the WUSB handler. The connection attributes enable the WUSB device to connect to the host device. At block 2210, the connection attributes are sent to the WUSB device through the trusted medium.

The following sections A-C are specific to the protocol used by a PONG system over the USB trusted medium and illustrates the layout of various interface and endpoint descriptors needed to implement PONG over USB on the PONG Target Device.

A. Pong Device Interface

Table 27 is a representation of the interface descriptor and provides details on the values to be filled in for a PONG device over USB. For most rows, a particular value or set of values is provided. Vendors may choose from the specified range and all other values may be RESERVED for future use.

TABLE 27

| Offset | Field | Size | Value | Description |
|---|---|---|---|---|
| 0 | bLength | 1 | 07h | Size of this descriptor in bytes |
| 1 | bDescriptorType | 1 | 04h | INTERFACE descriptor type |
| 2 | bInterfaceNumber | 1 | ??h | Zero-based value identifying the |
| | | | | index number. |
| 3 | bAlternateSetting | 1 | 00h | Alternate settings are not |
| | | | | necessary. |
| 4 | bNumEndpoints | 1 | 00h or 01h | Number of endpoints used |
| | | | | (excluding endpoint zero). Use |
| | | | | 00h if an optional interrupt |
| | | | | endpoint is not required, else use |
| | | | | 01h. |
| 5 | bInterfaceClass | 1 | ffh | Please use ffh to identify this |
| | | | | interface an vendor specific. The |
| | | | | Microsoft OS Descriptor will be |
| | | | | used to identify the Microsoft |
| | | | | class code for the PONG |
| | | | | interface. |
| 6 | bInterfaceSubClass | 1 | 00h | The value of 00h must be used |
| | | | | with class code set to 0xff |
| 7 | bInterfaceProtocol | 1 | 00h | The value of 00h must be used with |
| | | | | class code set to 0xff |
| 8 | iInterface | 1 | 00h | Index of string descriptor |
| | | | | describing this interface. |

A string may be used to identify the device that is being associated. The string may be localized in the USB string descriptors. An example of a good string would be “PONG—Wireless USB Mouse”. In one example embodiment, the PONG interfaces are not grouped with Interface Association Descriptor. A USB device may not be configured to have more than 1 PONG interface per configuration.

B. Pong Device Endpoints

To allow for really cheap devices, a control endpoint may be used and an interrupt endpoint is optional (for advanced features). Using the control endpoint also allows for Low Speed USB devices. The control endpoint (endpoint 0x00) does NOT need to be described under the interface descriptor and must be present on all USB devices.

Smart devices can choose to implement association functionality after device enumeration is completed. To achieve this, the device may implement the optional Interrupt IN endpoint. This endpoint will facilitate notifications of new association requests. An example of standard endpoint descriptor for this optional endpoint is shown in Table 28 as Interrupt-IN Endpoint Descriptor.

TABLE 28

| Offset | Field | Size | Value | Description |
|---|---|---|---|---|
| 0 | bLength | 1 | 07h | Size of this descriptor |
| | | | | in bytes |
| 1 | bDescriptorType | 1 | 05h | ENDPOINT descriptor |
| | | | | type |
| 2 | bEndpointAddress | 1 | 81-8Fh | The address of this |
| | | | | endpoint on the USB |
| | | | | device. This address is |
| | | | | an endpoint number |
| | | | | between 1 and 15. |
| | | | | Bit 0..3 Endpoint |
| | | | | number |
| | | | | Bit 4..6 Reserved, |
| | | | | must be 0 |
| | | | | Bit 7 1 = In |
| 3 | bmAttributes | 1 | 03h | This is an Interrupt |
| | | | | endpoint |
| 4 | wMaxPacketSize | 2 | 00??h | Maximum data |
| | | | | transfer size |
| 6 | bInterval | 2 | ??h | Interval for polling |
| | | | | endpoint for |
| | | | | data transfers. |
| | | | | Expressed in |
| | | | | milliseconds. Must be |
| | | | | in the |
| | | | | range from 1 to 255. |
| | | | | The recommended |
| | | | | value is 255. |

If a device's PONG interface does not contain the optional endpoint, association may occur at enumeration time. If such a device wishes to initiate the association process, it may perform a device initiated USB reset. This may cause the device to be re-enumerated by the host, at which point the host may retrieve the association requests from the device. A device could also implement HUB functionality to cause the device to come as go.

C. Pong Class Specific Requests

All PONG data transfers occur over the control endpoint. These transfers may be in the form of PONG class requests. Table 29 shows the list of PONG class requests that are supported by a PONG device. Calid values of bRequest are shown.

TABLE 29

| Request | Value | Section |
|---|---|---|
| GET_ASSOCIATION_INFORMATION | 0x01 | C.1. |
| GET_ASSOCIATION_REQUEST | 0x02 | C.2. |
| SET_ASSOCIATION_RESPONSE | 0x03 | C.3. |

C.1. Get Association Information

This request retrieves an association_information structure from the device. The association_information contains a list of REQUEST_INFO blocks. Each REQUEST_INFO block pertains to a single association request that the device wishes to issue. Table 30 shows an example GET_ASSOCIATION_INFORMATION request.

TABLE 30

| bmRequestType | bRequest | wValue | wIndex | wLength | Data |
|---|---|---|---|---|---|
| 10100001B | GET_ASSOCIATION_INFORMATION | 0x0000 | Interface | Length of | ASSOCIATION_INFORMATION |
| | | | | requested | |
| | | | | Data | |

Table 31 shows an example association_information data structure. The first few bytes (e.g. 3 bytes) of the data structure may be a header section.

TABLE 31

| Offset | Field | Size | Value | Description |
|---|---|---|---|---|
| 0 | PendingRequestCount | 1 | 0x00-0xff | Number of |
| | | | | pending requests |
| | | | | that are listed at |
| | | | | the end of this |
| | | | | structure |
| 1 | Flags | 2 | See Table | See Table 32 |
| | | | 32 | |
| 3 | RequestInfoArray | Sizeof(REQUEST_INFO) * | 0x000000-0xffffffff | Array of |
| | | PendingRequestCount | | REQUEST_INFO |
| | | | | structures. (See |
| | | | | Table 33) |

Table 32 shows example association_information flags.

TABLE 32

| | Flag | |
|---|---|---|
| Flag Name | Value | Description |
| AdditionalRequests | 0x0001 | If this flag is set, it indicates that the |
| | | device may have additional association |
| | | requests pending after the current set. |
| | | This being set results in the host sending |
| | | another |
| | | GET_ASSOCIATION_INFORMATION |
| | | after the current set of association |
| | | requests have been handled. They may |
| | | be useful for devices that have explicit |
| | | ordering concerns, or who may issue a |
| | | request as a result of a specific response. |
| | | If this is not set, it indicates to the host |
| | | that it doesn't need to issue another |
| | | GET_ASSOCIATION_INFORMATION |
| | | request. |

Table 33 shows a request_info structure.

TABLE 33

| Offset | Field | Size | Value | Description |
|---|---|---|---|---|
| 0 | RequestID | 1 | 0x00-0xff | This field identifies a |
| | | | | specific association |
| | | | | request. This value will |
| | | | | be used to retrieve |
| | | | | the request and send |
| | | | | the response. |
| 1 | RequestSize | 4 | 0x00000000- | This is the size in bytes |
| | | | 0xffffffff | of the particular |
| | | | | association request. |

C.2. GET_ASSOCIATION_REQUEST

This request retrieves a particular association request from the device. The request is identified by the RequestID value in the wValue field. Table 34 shows an example GET_ASSOCIATION_REQUEST request.

TABLE 34

| bmRequestType | bRequest | wValue | wIndex | wLength | Data |
|---|---|---|---|---|---|
| 10100001B | GET_ASSOCIATION_REQUEST | RequestID | Interface | Length of | Association |
| | | BlockNumber | | requested | Request |
| | | | | Data | |

A request block may be a 4 KB block of data. The maximum transfer size of a control transfer may be set at 64 KB. Accordingly, 16 request blocks can be theoretically transferred in each GET_ASSOCIATION_REQUEST. The actual amount of data to be transferred is specified by the wLength field. The BlockNumber specified in the wValue field identifies the starting block number for this control transfer. The device may return association request data for the request specified by RequestID starting at offset BlockNumber * 4 KB, and transferring wLength bytes.

C.3. SET_ASSOCIATION_RESPONSE

This request sends a response to a specific association request identified by the RequestID value in the wValue field. Table 35 shows an example SET_ASSOCIATION_RESPONSE.

TABLE 35

| bmRequestType | bRequest | wValue | wIndex | wLength | Data |
|---|---|---|---|---|---|
| 00100001B | SET_ASSOCIATION_RESPONSE | RequestID | Interface | Length of | Association |
| | | TransferFlags | | response | Response |
| | | | | Data | |

The TrasferFlags value is the bitwise or of zero or more of the values. An example TrasferFlags value is shown in TABLE 36.

TABLE 36

| Flag Name | Flag Value | Description |
|---|---|---|
| LastBlock | 0x01 | If this flag is set, it indicates |
| | | that this is the last control |
| | | transfer that contains data |
| | | for this specific Association |
| | | Response. This facilitates |
| | | chaining of control transfers |
| | | for large responses. |

The PONG system may implement interrupt IN messages. For example, a NewAssociationRequest is an interrupt IN message that may be used to indicate to the host that the device has new or modified association requests that need to be processed. Upon receiving this message, the host will issue a GET_ASSOCIATION_INFORMATION request, and process the requests accordingly. Table 37 shows an example NewAssociationRequest.

TABLE 37

| Offset | Field | Size | Value | Description |
|---|---|---|---|---|
| 0 | bMessageType | 1 | 50h | New association request event |
| 1 | bRequestCount | 1 | 0x00- | Number of pending requests |
| | | | 0xff | that may be |
| | | | | returned in a subsequent |
| | | | | GET_ASSOCIATION_{—} |
| | | | | INFORMATION. |
| | | | | This field is really a hint |
| | | | | to the host to determine |
| | | | | how large of a buffer it |
| | | | | needs to allocate in order |
| | | | | to receive the |
| | | | | association information. |

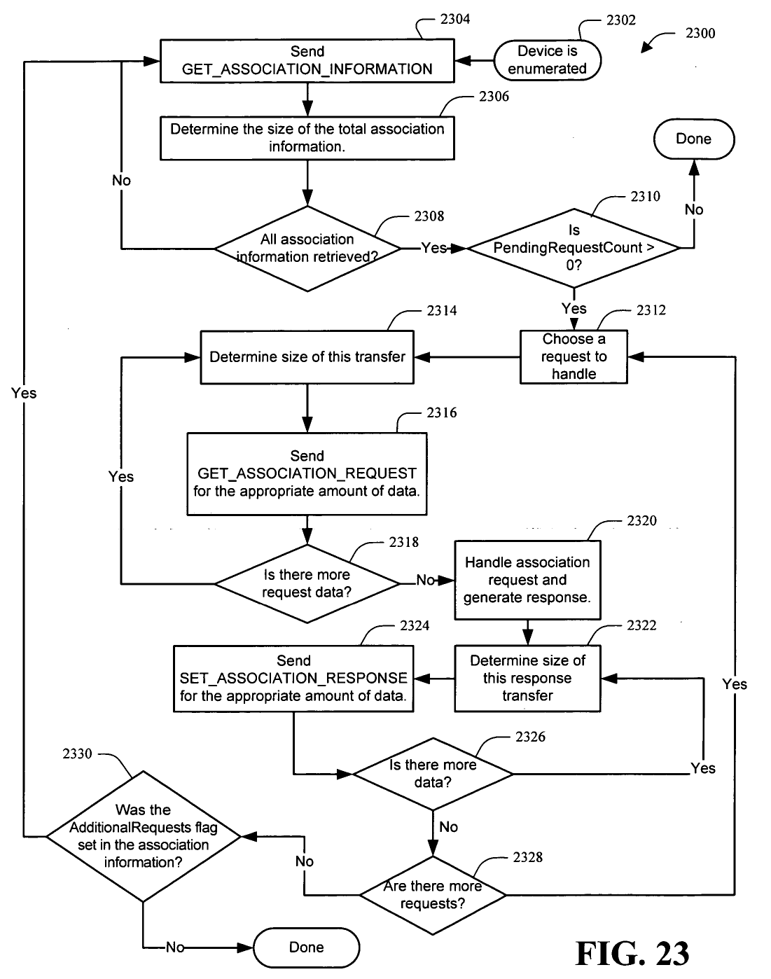

FIG. 23 shows an example process 2300 for associating a device using the particular data structures described herein. Example process 2300 may be implemented in an extensible architecture, such as a PONG system, for a HOST to configure devices with USB. Process 2300 may be implemented in conjunction with requests and responses discussed above.

At block 2304, GET_ASSOCIATION_INFORMATION is sent. In one implementation, the request includes at least 3 bytes of data. At block 2306, the size of the total association information is determined. The size may be determined by
Size=3+sizeof(REQUEST^{—}INFO)* PendingRequestCount

At decision block 2308, a determination is made whether all association information have been received. If not, process 2300 returns to block 2304. If all association request have been received, process 2300 moves to decision block 2310 where a determination is made whether there is any pending request. For example, the determination may be made by determining whether the PendingRequestCount data structure is greater than 0. If there is no pending request (e.g. PendingRequestCount=0), process 2300 ends. If there are pending requests, process 2300 goes to block 2312 where the process chooses a request to handle.

At block 2314, the size of the transfer is determined. This size may be determined by
Size=max(bytes left, N*4 KB (where 0<N<=16))

At block 2316, GET_ASSOCIATION_REQUEST is sent for the appropriate amount of data. RequestID should match that in the association information. BlockNumber should be the starting block number to be returned. At decision block 2318, a determination is made whether there is more request data. If so, process 2300 returns to block 2314, If not, the process goes to block 2320 where the association request is handled and a response is generated.

At block 2322, the size of the response transfer is determined. At block 2324, GET_ASSOCIATION_RESPONSE is sent for the appropriate amount of data. RequestID should match that of the request. If this transfer contains the last byte of the response, then LastBlock should be set. At decision block 2326, a determination is made whether there is more data. If so, process 2300 goes back to block 2322. If there is no more data, the process continues at decision block 2328 where a determination is made whether there are more requests. If so, process 2300 goes back to block 2312. If there are no more requests, the process moves to decision block 2330 where a determination is made whether the AdditionalRequests flag was set in the association information. If so, process 2300 goes back to block 2304. If the flag is not set, the process ends.

It may be possible that a device that supports a PONG interface is not actually ready to send a PONG Association Request at the time of device enumeration. For example, maybe the device is actually some type of cradle for other devices that support PONG over some proprietary interface. The USB PONG device was already enumerated long before the target device is inserted into the cradle. The above described systems and techniques provide a mechanism to notify the PONG driver that it needs to retrieve new association information.

There may also be a need for certain devices to support multiple association requests (e.g. device with multiple target media). These individual association requests could either be dependant on one another or totally independent. Independent association is where a device wishes to associate multiple target media at once, without caring about the order of associating the target media. The above described systems and techniques support a scenario where after receiving an association response from the host, the device decides to issue a new association request as a result of that response.

What has been described above includes examples of the described subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. One or more device-readable media encoded with device-executable instructions for performing steps comprising:
identifying an association request from a wireless universal serial bus (WUSB) device through a trusted medium;
parsing the association request;
generating device attributes describing the WUSB device;
sending the device attributes to a handler for WUSB devices;
receiving connection attributes from the handler; and
sending the connection attributes to the WUSB device through the trusted medium.

2. The one or more device-readable media as recited in claim 1, further comprising:
identifying an association type identifier included in the association request;
determining that the type of the association being requested is WUSB; and
identifying the handler based on the type.

3. The one or more device-readable media as recited in claim 1, further comprising validating the parsed association request based on a standard associated with WUSB.

4. The one or more device-readable media as recited in claim 1, further comprising enabling the WUSB device to connect through a wireless medium in accordance with the connection attributes.

5. The one or more device-readable media as recited in claim 1, wherein the trusted medium is a wired medium.

6. The one or more device-readable media as recited in claim 1, wherein the trusted medium includes at least one of a wired USB connection, a firewire connection, an Ethernet connection, a serial connection, a parallel connection, a wireless connection, a near field communication (NFC) connection, or an infrared (IR) connection.

7. The one or more device-readable media as recited in claim 1, wherein the device attributes include at least one of an association type identifier, a connection device identifier, a connection key identifier, a device setup class GUID, supported band group, or an integrator site URL.

8. The one or more device-readable media as recited in claim 1, wherein the connection attributes include at least one of a connection host identifier, a connection device identifier, a connection key identifier, preferred channels, or host region.

9. A connecting device comprising a wireless universal serial bus (WUSB) component, the connecting device configured to send an association request to a host device through a trusted medium, the association request including device attributes related to the connecting device, the connecting device further configured to receive connection attributes from the host device and to establish a WUSB connection with the host device using the connection attributes.

10. The connecting device as recited in claim 9, wherein the trusted medium is a wired connection.

11. The connecting device as recited in claim 10, further comprising a wired component configured to communicate with the host device through the wired connection.

12. The connecting device as recited in claim 11, wherein the wired connection includes at least one of a wired USB connection, a firewire connection, an Ethernet connection, a serial connection, or a parallel connection.

13. The connecting device as recited in claim 10, wherein the device attributes include at least one of an association type identifier, a connection device identifier, a connection key identifier, a device setup class GUID, supported band group, or an integrator site URL.

14. The connecting device as recited in claim 10, wherein the connection attributes include at least one of a connection host identifier, a connection device identifier, a connection key identifier, preferred channels, or host region.

15. The connecting device as recited in claim 10, wherein the connecting device is further configured to arrange the WUSB component and to connect to the host device using the connection attributes.

16. A method of communication between a connecting device and a host device, the connecting device and the host device being connected with a wired medium, the method comprising:
sending, from the connecting device to the host device through the wired medium, an association request including device attributes related to a WUSB component of the connecting device;
determining, by the host device, connection attributes related to WUSB connections;
sending, from the host device to the connecting device through the wired medium, a response that includes the connection attributes; and
establishing, by the connecting device, a connection with the host device using the connection attributes.

17. The method as recited in claim 16, wherein the device attributes include at least one of an association type identifier, a connection device identifier, a connection key identifier, a device setup class GUID, supported band group, or an integrator site URL.

18. The method as recited in claim 16, wherein the connection attributes include at least one of a connection host identifier, a connection device identifier, a connection key identifier, preferred channels, or host region.
